(19) United States
(12) Patent Application Publication
(10) Pub. No.: US 2013/0082951 A1
(43) Pub. Date: Apr. 4, 2013

(54) TOUCH SENSOR, AND CONTROLLER PROVIDED WITH THE TOUCH SENSOR

(71) Applicants: Hisanori TANAKA, Hamamatsu-shi (JP); Mitsunori OCHI, Hamamatsu-shi (JP); Masanori KAMIHARA, Hamamatsu-shi (JP); Ryohei KOGA, Hamamatsu-shi (JP); Tsuneo SHIMIZU, Hamamatsu-shi (JP); Junji ENDO, Hamamatsu-shi (JP)

(72) Inventors: Hisanori TANAKA, Hamamatsu-shi (JP); Mitsunori OCHI, Hamamatsu-shi (JP); Masanori KAMIHARA, Hamamatsu-shi (JP); Ryohei KOGA, Hamamatsu-shi (JP); Tsuneo SHIMIZU, Hamamatsu-shi (JP); Junji ENDO, Hamamatsu-shi (JP)

(73) Assignee: YAMAHA CORPORATION, Hamamatsu-shi (JP)

(21) Appl. No.: 13/599,006

(22) Filed: Aug. 30, 2012

(30) Foreign Application Priority Data
Aug. 30, 2011 (JP) 2011-188034
Aug. 31, 2011 (JP) 2011-188805

(51) Int. Cl. G06F 3/041

(52) U.S. Cl. CPC G06F 3/041
USPC 345/173

(57) ABSTRACT

One electrode and another electrode adjoining an upper end region of the one electrode in an operating direction of a fader sensor are divided by a boundary line extending zigzag in a generally M shape transversely relative to the operating direction, so that upper and lower apex portions of the one electrode and the other electrode bite into each other. Similarly, the one electrode and another electrode adjoining a lower end region of the one electrode each other are divided by a boundary line extending zigzag in a generally M shape transversely relative to the operating direction. As a finger touches the fader sensor, the finger simultaneously touches the three electrodes, and corresponding output signals are output therefrom. A weighted average of the output signals is calculated so that position information of the finger having touched the sensor can be acquired with a high resolution.

### BACKGROUND

The present invention relates generally to touch sensors, such as faders or sliders, for detecting a user-operated position in a one-dimensional operating direction, and more particularly to a touch sensor applicable to controllers for manipulating or setting a parameter related to audio signal processing or any of other various signal processing.

The present invention also relates to an improvement of display structures in fader controllers provided with a touch sensor.

In the field of audio signal processing apparatus using a computer, it has heretofore been known to perform audio processing, such as recording, editing, mixing, etc. of performance data, through digital signal processing. The computer used in such audio signal processing apparatus is a general-purpose computer like a PC (Personal Computer), which includes various hardware devices, such as an audio interface and MIDI (Musical Instrument Digital Interface) interface. Further, the computer has installed therein an application program for performing audio signal processing functions. Thus, the computer performs or implements audio signal processing functions, such as recording and editing, effect impartment and mixing of audio signals. Such audio signal processing apparatus are often called digital audio workstations or DAWs. In the following description, the application program for causing the computer to perform such a DAW function will hereinafter be referred to as “DAW software”.

The DAW software operating in PCs has been well-developed to the extent that even an individual person can readily create music by installing the DAW software in a PC. Further, the number of functions performed by the DAW software and hence parameters therefor has been increasing, so that it is difficult to manipulate all of the parameters through operation of a mouse alone. So, it has nowadays become conventional to remote-control parameters of the DAW by us of a touch sensor provided on a remote controller that is dedicated to DAW operation and connected to a PC having the DAW software installed therein. Such a technique is disclosed, for example, in “Steinberg Media Technologies GmbH CC121 Operation Manual” available on the Internet at <ftp: ftp.steinberg.net/Download/Hardware/CC121/CC121_OperationManual_ja.pdf>.

The controller externally connected to the PC having the DAW software installed therein is of a small size such that a human operator or user can hold the controller with one hand and operate the controller with the other hand, and various operators are provided on a panel of the controller. The operators include a plurality of (e.g., four) fader sensors each in the form of a vertically-elongated touch sensor. By a human operator or user sliding its finger on and along the fader sensors, fader levels of channels assigned to the fader sensors can be adjusted. For such adjustment based on the fader sensor, it is desired to finely adjust the fader level, but the fine fader level adjustment would require an increased resolution of the fader sensor. The resolution of the fader sensor depends on the number of electrodes formed on the fader sensor for detecting that the fader sensor has been touched. However, because the controller is of a small size, each of the fader sensors too has to be small in size, so that the number of electrodes formed on the fader sensor cannot be increased as desired. As a consequence, there would be encountered the problem that the resolution of the touch sensors cannot be increased as desired.

In various electronic apparatus including electronic musical instruments like an electronic piano and electronic organ and audio apparatus like a mixer apparatus, there is provided an operator device including operators, such as switches, for selecting any of various functions like impartment of sound effects and for adjusting a sound volume, sound color, etc. In many cases, such an operator device includes display sections equipped with light emitting elements for visually displaying operating states. One example of the conventionally-known operator device is a fader mechanism disclosed in Japanese Patent Application Laid-open Publication No. 2005-323122 (hereinafter referred to as “patent literature 1”).

The fader mechanism disclosed in patent literature 1 is a mechanical type fader mechanism that includes a base member in the form of a linear slide volume (variable resistance) or linear encoder, and a slider knob mounted on the base member for movement by a finger of a user. A resistance value varying in response to the user moving the slider knob on and along a slide rail is read to continuously change a parameter value of an apparatus or equipment to be operated. An amount (level) of such user's manual operation is detected, so that a fader gain of a corresponding input channel, for example, is adjusted in accordance with the detected operation level. Further, in the fader device disclosed in patent literature 1, lamps constituting display sections are arranged on a side of the operator (i.e., on a side relative to the sliding direction of the slider knob).

Another example of the conventionally-known operator device is an illumination type operator device disclosed in Japanese Patent No. 3687170 (hereinafter referred to as “patent literature 2”). The operator device disclosed in patent literature 2 includes an operator section provided underneath a transparent panel. The operator section includes a recessed portion formed by a partitioning wall, a light detecting element provided centrally in the recessed portion, illuminating elements provided around the light detecting element for indicating that the operator section has been selected, and a light-blocking tubular member vertically provided between the light detecting element and the illuminating elements. The light detecting element constitutes a light switch that is normally in an ON state by receiving illumination light from an upper light source and that is turned off when a finger has been put on the transparent panel to cover a region over the light-blocking tubular member so that the illumination light is blocked. In the operator device, a plurality of such operator sections are arranged in a straight line, so that, as a finger slidingly moves on and along the upper surface of the transparent panel along the arranged direction of the operator sections, the sliding movement of the finger can be continuously detected.

Still other examples of the operator device are operator devices (operator units) disclosed in Japanese Utility Model Application No. SHO-61-127524 (hereinafter referred to as “patent literature 3”) and Japanese Patent No. 3209050 (hereinafter referred to as “patent literature 4”). Each of the operator units disclosed in patent literature 3 and patent literature 4 identified above includes a plurality of push buttons arranged in a straight line configuration, and an illumination section including a plurality of light emitting diodes (LEDs) arranged on a side lateral to the arranged direction of the push buttons. As the plurality of push buttons are successively operated with a finger of a human operator or user along the arranged direction of the push buttons, the finger movement is detected, and operating states of the push buttons are displayed by the illumination section.

However, the aforementioned conventionally-known operator devices would present the following problems. Namely, in each of the operator devices disclosed in patent literatures 1, 3 and 4, the display elements (light emitting elements) are arranged on a side along the sliding direction of the operator section and in spaced relation to the operator section. Because the display elements (light emitting elements) are provided on a side of the operating section in spaced relation to the operator section, it would be difficult for an operation feeling, with which the user operates the operator section, and display positions of the display elements to intuitively match each other, and thus, it would be difficult for the user to operate the operator section intuitively. Further, because the display elements (light emitting elements) are provided on a side of the operating sections in spaced relation to the operation section, the operator device would have an increased width dimension, so that a necessary installation area for the operator device cannot be reduced as desired.

Further, in the operator device disclosed in patent literature 2, a plurality of the operator sections, including the light detection means for detecting user's operation, switches, etc., are not provided continuously in their arranged directions; they are arranged in a so-called steppingstone fashion. Thus, a detection signal responsive to user's sliding operation, where a user's finger or the like is sled linearly, becomes stepwise, so that the sliding operation cannot be detected continuously and smoothly.

Further, in the case where user's operation is detected via the light detection means as in the operator device disclosed in patent literature 2, erroneous detection would take place with a considerably high frequency. Therefore, in this case, it is common to perform signal processing with given modulation intended to reduce the frequency of erroneous detection.

Furthermore, in place of the aforementioned mechanical switches and light-detection type operator devices, another type of operator device is used nowadays, which includes an electrostatic capacitance sensor constructed to detect, based on an electrostatic capacitance change, that a part of a user's body, such as a finger, has approached or touched an electrode. An example of this type of operator device including the electrostatic capacitance sensor is disclosed in Japanese Patent Application Laid-open Publication No. 2010-286981 (hereinafter referred to as “patent literature 5”). More specifically, the operator device disclosed in patent literature 5 is constructed to detect position information of a sliding finger via the electrostatic capacitance sensor.

However, the operator device disclosed in patent literature 5 is complicated in construction and operating principle and thus tends to become great in size. Further, if the operator device including the electrostatic capacitance sensor, such as the operator device disclosed in patent literature 5, is constructed to continuously detect sliding movement of a user's finger, and if the detecting electrode is provided with a midway break, then detection values would become stepwise. To avoid the stepwise detection values, display sections displaying operating states cannot be provided within a sensor region and have to be provided outside the sensor region.

### SUMMARY OF THE INVENTION

In view of the foregoing prior art problems, it is an object of the present invention to provide an improved touch sensor which is provided on a controller and which can achieve an enhanced detection resolution even with a small number of electrodes for detecting that the sensor has been touched.

It is another object of the present invention to provide an improved touch-sensitive, fader type controller which can reduce a necessary installation area therefor despite provision of display sections for displaying an operated position, which allows an operation feeling and display by the display sections to intuitively match each other and which permits acquisition of an accurate operated position through continuous position detection, and a controller device provided with such a touch-sensitive, fader type controller.

In order to accomplish the above-mentioned objects, the present invention provides an improved touch sensor for detecting a user-operated position, in a one-dimensional operating direction, on the touch sensor, which comprises a plurality of touch sensitive patterns formed on a surface of the touch sensor adapted to be touched by a user, the plurality of touch sensitive patterns being sequentially arranged along the operating direction with a boundary between each pair of adjoining ones of the touch sensitive patterns formed in a zigzag formation, each of the touch sensitive patterns being configured to generate an output signal corresponding to user's touch on the surface.

According to the present invention, the plurality of touch sensitive patterns (e.g., electrode patterns) are formed in such a manner that the boundary between each pair of adjoining ones of the touch sensitive patterns is formed in a zigzag configuration or formation. Because of the presence of touch sensitive pattern portions oblique to the one-dimensional operating direction, the detecting accuracy can be significantly increased even with a small number of the touch sensitive patterns (electrode patterns). Further, with the boundary between each pair of adjoining ones of the touch sensitive patters formed in a zigzag configuration or formation, the touch sensitive patterns can be readily constructed in such a manner that a user's (human operator's) finger can simultaneously touch two or more of the touch sensitive patterns (preferably at least touch sensitive patterns) in most part of the touch sensor no matter which position of the touch sensor the finger touches. Furthermore, with the boundary between each pair of adjoining ones of the touch sensitive patterns formed in a zigzag formation, it is possible to readily prevent undesired, variation or fluctuation of the detection output signals even when the finger having touched the touch sensor shifts laterally with respect to the one-dimensional operating direction, as long as the lateral shift does not involve any change in position in the one-dimensional operating direction (i.e., the lateral shift maintains a same transverse position relative to the one-dimensional operating direction).

In an embodiment, the touch sensor of the invention further comprises an arithmetic operation section configured to generate a detection signal indicative of a current operated position by synthesizing the output signals from the individual touch sensitive patterns.

Further, in an embodiment, the arithmetic operation section generates the detection signal indicative of a current operated position by multiplying the output signals, generated from all of the touch sensitive patterns, by weighting coefficients set according to arranged order of the touch sensitive patterns and then calculating a weighted average of the output signals.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a diagram showing an example construction where controllers each provided with a fader sensor, which is an embodiment of a touch sensor of the present invention, is connected to a personal computer (PC);

FIG. 2 is a diagram showing an example of a GUI screen of DAW software running in the PC which has connected thereto the controllers, each provided with the fader sensor which is the embodiment of the touch sensor of the present invention;

FIG. 3 is a diagram showing constructions of one fader sensor, which is the embodiment of the touch sensor of the present invention, and circuitry of the fader sensor;

FIG. 4 is an example circuit diagram of the circuitry of the fader sensor which is the embodiment of the touch sensor of the present invention;

FIG. 5 is a waveform diagram showing signal, waveforms in various portions of the circuitry of the fader sensor which is the embodiment of the touch sensor of the present invention;

FIG. 6 is a diagram showing a construction of electrodes of the fader sensor which is the embodiment of the touch sensor of the present invention;

FIG. 7 is a diagram outlining an example manner in which a touched position on the fader sensor is detected;

FIGS. 8A and 8B are diagrams showing an example specific construction of the fader sensor;

FIG. 9 is a diagram outlining another example manner in which a touched position on the fader sensor is detected;

FIGS. 10A and 10B are diagrams showing modified constructions of the electrodes of the fader sensor;

FIGS. 11a and 11B are diagrams showing still other modified constructions of the electrodes of the fader sensor;

FIG. 12 is a perspective view showing an outer appearance of a music piece data input device provided with the fader type controller of the present invention;

FIG. 13 is an exploded perspective view showing component parts of the music piece data input device of FIG. 12;

FIG. 14 is a fragmentary enlarged view of switch contact patterns and LED elements provided on a circuit substrate of the music piece data input device of FIG. 12;

FIG. 15A is a perspective view taken from above the upper surface of a fader substrate of the music piece data input device, which shows the fader substrate and component parts peripheral to the fader substrate, and FIG. 15B is a perspective view taken from below the lower surface of the fader substrate;

FIG. 16A is a plan view showing a detailed construction of a fader section of the music piece data input device, FIG. 16B is a sectional view taken along the X-X line of FIG. 16A, and FIG. 16C is a sectional side view of an electrode section of the fader section;

FIG. 17 is a block diagram schematically showing a construction of operation detection circuitry (position information acquisition section) for detecting user's operation on a fader type controller in the music piece data input device;

FIG. 18 is a flow chart showing an operational sequence of detection processing for detecting user's operation on the fader type controller in the music piece data input device;

FIG. 19 is a block diagram showing an example hardware construction of the music piece data input device;

FIG. 20 is a flow chart showing a processing flow (main flow) of processing responsive to user's operation on the music piece data input device; and

FIG. 21 is an exploded perspective view showing component parts of another embodiment of the music piece data input device of the present invention.

### DETAILED DESCRIPTION OF THE INVENTION

### Embodiment of Touch Sensor

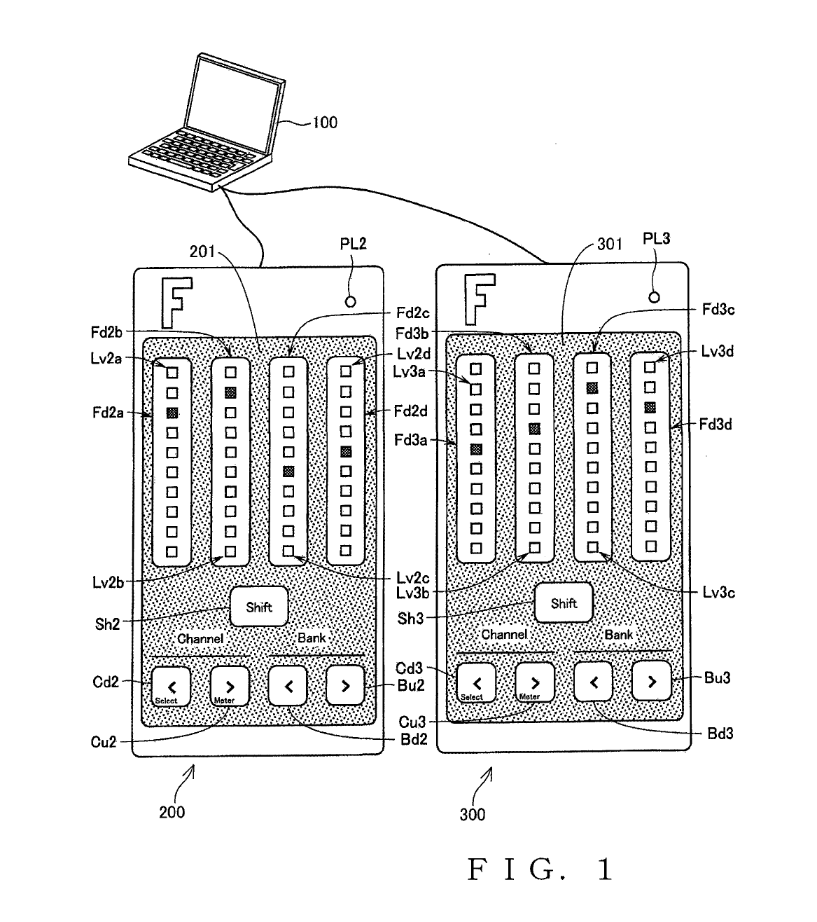

Next, a description will be given about an embodiment of a touch sensor of the present invention. FIG. 1 is a diagram showing an example construction where controllers each provided with a fader sensor, which is the embodiment of the touch sensor of the present invention, are connected to a personal computer (hereinafter referred to as “PC”). In FIG. 1, the PC 100 has installed therein DAW software which is application software called “DAW” (Digital Audio Workstation) for implementing audio processing functions, such as recording and editing, effect impartment and mixing of performance data. Two external remote controllers 200 and 300, each of which is a dedicated controller for operating the DAW software, are connected to the PC 100. The PC 100 is equipped with a plurality of USB (Universal Serial Bus) terminals of the USB interface standard that is one of serial interface standards for interconnecting the PC 100 and peripheral devices, and the external remote controllers 200 and 300 too are equipped with USB terminals. The PC 100 and the external remote controllers 200 and 300 are communicatably interconnected by their respective USB terminals being interconnected via USB cables. The external remote controllers 200 and 300 are capable of remote-controlling parameters of a plurality of input channels and a plurality of output channels in the DAW software.

Whereas two external remote controllers 200 and 300 are connected to the PC 100 in the illustrated example of FIG. 1, up to n (e.g., four) external remote controllers are connectable to the PC 100. The two external remote controllers 200 and 300 are constructed similarly to each other, and thus, the following describe the construction of the external remote controller 200 by way of example.

As shown in FIG. 1, the external remote controller 200 includes, on its panel surface 201, four fader sensors Fd2a, Fd2b, Fd2c and Fd2d. Each of the four fader sensors Fd2a, Fd2b, Fd2c and Fd2d is in the form of a vertically-elongated touch sensor, and a different channel can be assigned to each of the fader sensors Fd2a, Fd2b, Fd2c and Fd2d. Each of these touch sensors is constructed to output an operated position detection signal by detecting a position of the touch sensor touched with a finger of a human operator or user (i.e., user-touched, operated position on the touch sensor). The thus-output operated position detection signal is used, for example, for setting a fader level of an audio signal of a channel assigned to the fader sensor (touch sensor) Fd2a-Fd2d. Namely, as known in the field of ordinary faders, one touch sensor corresponding to any one of the fader sensors Fd2a to Fd2d detects a user-touched, operated position in a one-dimensional operating direction of the touch sensor. The “one-dimensional operating direction” refers to not only one where a linear or straight trajectory is drawn as in the illustrated example, but also one where a curved trajectory is drawn.

Display sections Lv2a, Lv2b, Lv2c and Lv2d, each comprising a plurality of LEDs arranged at substantially equal intervals along the longitudinal axis of the fader sensor Fd2a-Fd2d, are provided inside (underneath) portions of the panel surface 201 that are covered with the fader sensors Fd2a-Fd2d. In each of the display sections Lv2a to Lv2d, any one of the LEDs that corresponds to a current position of the fader of the channel assigned to the fader (current fader level) is illuminated. Once a human operator or user touches any one of the fader sensors Fd2a to Fd2d with its finger, the position of the fader is moved to the touched position, so that the illuminated LED in the display section Lv2a-Lv2d moves in interlocked relation to the moved fader position. In this case, the current position of the fader represents a current fader level of the channel, and thus, the fader level can be adjusted by the user causing its finger to touch the corresponding fader sensor Fd2a-Fd2d.

Although a description about the construction of the external remote controller 300 is omitted here because the external remote controller 300 is constructed similarly to the external remote controller 200, it should be noted that the fader level of any one of the channels assigned to the fader sensors Fd3a to Fd3d can be adjusted by the user causing its finger to touch the corresponding fader sensor Fd3a-Fd3d.

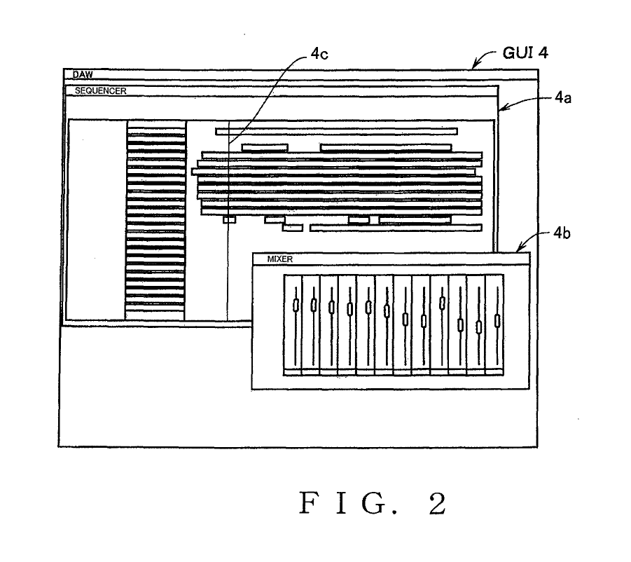

FIG. 2 shows an example of a GUI (Graphical User Interface) screen 4 of the DAW in the PC 100 which has the external remote controllers 200 and 300 connected thereto as shown in FIG. 1 and in which the DAW software is running. In the illustrated example of FIG. 2, a window 4a of a sequencer and a window 4b of a mixer are displayed on the GUI screen 4 of the DAW. The window 4a is a GUI of the sequencer via which a music piece can be created, and information of a plurality of tracks of performance data and performance data of the individual tracks are displayed time-serially in elongated rectangles. Once a reproduction (playback) button is depressed, a cursor 4c starts moving rightward at a speed corresponding to a predetermined tempo, so that performance data of the individual tracks corresponding to each current position of the cursor are reproduced. A mixer function is also implemented with the DAW software, and, in reproduction, audio signals of the individual tracks are output after being mixed by the mixer. The window 4b is a GUI of the mixer via which audio signals of the individual tracks are mixed, and on which are displayed at least faders of a plurality of channels for adjusting mixing levels of the individual tracks. By dragging and moving any desired one of the faders on the screen, the user can adjust the fader level of the channel (track) assigned to the fader and thereby adjust the mixing level of the channel.

In the illustrated example of FIG. 2, the faders of 12 (twelve) channels are displayed on the window 4b, and channels comprising the tracks displayed on the window 4a are assignable to the respective faders.

Operated positions of the faders can be remote-controlled using the external remote controller 200 in place of the faders displayed on the window 4b. In this case, operated positions of the faders of the four channels assigned to the fader sensors Fd2a to Fd2d of the external remote controller 200 can be remote-controlled via the external remote controller 200. In the illustrated example, four channels of desired ascending consecutive channel numbers, for example, are assignable to the fader sensors Fd2a to Fd2d; channels of nonconsecutive channel numbers are not assignable to the fader sensors Fd2a to Fd2d. The assigned four channels can be changed by the user depressing a channel shift button provided in a “Channel” section on the external remote controller 200 or a bank shift button provided in a “Bank” section on the external remote controller 200. If the user depresses a “<” channel shift button Cd2 in the “Channel” section, the channels assigned to the fader sensors Fd2a to Fd2d are shifted by one in a channel-number decreasing direction. More specifically, if the user depresses the “<” channel shift button Cd2 with channels ch3 to ch6 assigned to the fader sensors Fd2a to Fd2d, then channels ch2 to ch5 will be assigned to the fader sensors Fd2a to Fd2d. Further, if the user depresses a “>” channel shift button Cu2 in the “Channel” section, the channels assigned to the fader sensors Fd2a to Fd2d are shifted by one in a channel-number increasing direction. For example, if the user depresses the “>” channel shift button Cu2 with channels ch3 to ch6 assigned to the fader sensors Fd2a to Fd2d, then channels ch4 to ch7 will be assigned to the fader sensors Fd2a to Fd2d. Because the channels displayed on the window 4b are of channel numbers sequentially increasing in a left-to-right direction, the “<” button Cd2 may be called “leftward channel shift button”, while the “>” button Cu2 may be called “rightward channel shift button”.

Further, if the user depresses a “<” button Bd2 in the “Bank” section, the channels assigned to the fader sensors Fd2a to Fd2d are shifted by one bank (in this case, four channels) in the channel-No. decreasing direction. For example, if the user depresses the “<” button Bd2 with channels ch6 to ch9 assigned to the fader sensors Fd2a to Fd2d, then channels ch2 to ch5 will be assigned to the fader sensors Fd2a to Fd2d. If the user depresses a “>” button Bu2 in the “Bank” section, the channels assigned to the fader sensors Fd2a to Fd2d are shifted by one bank (four channels) in the channel-No. increasing direction. For example, if the user depresses the “>” button Bu2 with channels ch6 to ch9 assigned to the fader sensors Fd2a to Fd2d, then channels ch10 to ch13 will be assigned to the fader sensors Fd2a to Fd2d. Thus, the “<” button Bd2 may be called “leftward bank shift button”, while the “>” button Bu2 may be called “rightward bank shift button”.

Namely, by the user depressing the channel shift button Cd2 or Cu2 or bank shift button Bd2 or Bu2, four channels of desired consecutive channel numbers can be assigned to the fader sensors Fd2a to Fd2d.

As noted above, four channels of desired ascending consecutive channel numbers can be assigned to the fader sensors Fd2a to Fd2d independently of a channel selected on the window Wb of the PC 100. Note, however, that, if the user simultaneously depresses the “<” button Cd2 and a “Shift” button Sh2 of the external remote controller 200, the function of the button Cd2 is switched to a “Select” function, so that four channels of desired ascending consecutive channel numbers, starting with the channel currently selected on the window 4b of the PC 100, are assigned to the fader sensors Fd2a to Fd2d. For example, if channel ch3 is currently selected on the window 4, channels ch3 to ch6 will be assigned to the fader sensors Fd2a to Fd2d. Further, if the user simultaneously depresses the “>” button Cu2 and the “Shift” button Sh2, the function of the button Cu2 is switched to a “Meter” function (i.e., level meter display function) so that input levels of four channels assigned to the fader sensors Fd2a to Fd2d are displayed on the corresponding display sections Lv2a to Lv2d. If the user operates, i.e. slides its finger on and along, any one of the fader sensors Fd2a to Fd2d while level meters are displayed in response to simultaneous depression of the “>” button Cu2 and the “Shift” button Sh2, the display section of the operated fader displays an operated position of the fader for a given time period and then returns back to the level meter display. Note that the above-mentioned level meter display function is in an OFF state when the external remote controller 200 is activated.

The external remote controller 300 has the same functions as the aforementioned external remote controller 200; namely, the external remote controllers 200 and 300 are constructed to behave in a similar manner.

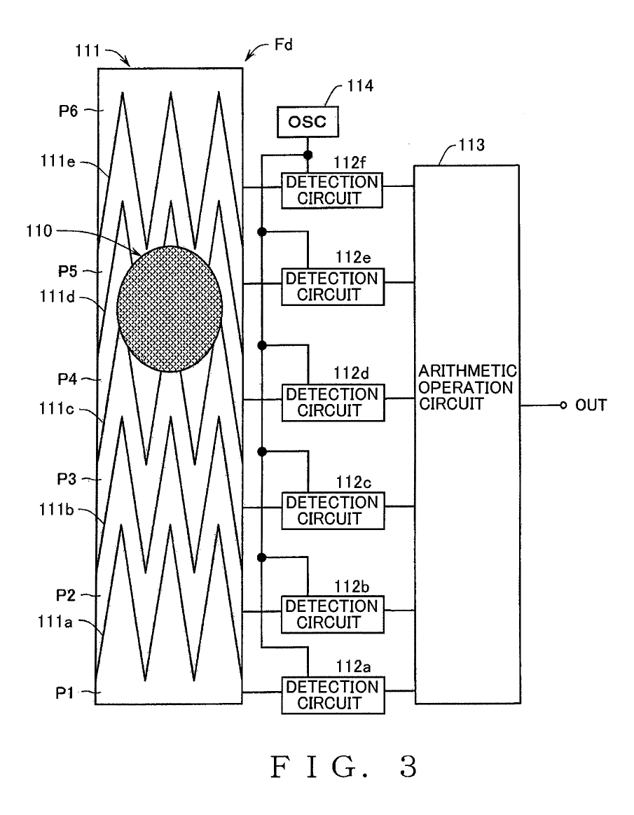

FIG. 3 shows constructions of the fader sensor Fd that is an embodiment of the touch sensor of the present invention and circuitry of the fader sensor Fd. Note that the fader sensor Fd is any one of the fader sensors Fd2a to Fd2d and Fd3a to Fd3d provided in the external remote controllers 200 and 300.

As shown in FIG. 3, the fader sensor Fd comprises an elongated rectangular, insulating substrate 111, and touch sensitive patterns (electrode patterns) formed on one surface of the insulating substrate 111 and comprising a plurality of electrodes P1, P2, P3, P4, P5 and P6. The insulating substrate 111 is, for example, a glass epoxy substrate or a Teflon substrate. In the illustrated example, six electrodes P1 to P6 constituting the touch sensitive patterns (electrode patterns) are sequentially arranged in a down-to-up direction (i.e., down-to-up direction as viewed in the figure). Note that that the number of the electrodes constituting the touch sensitive patterns (i.e., the number of the patterns) is not necessarily limited to six and may be less or more than six, as long as a plurality of the touch sensitive patterns are sequentially arranged along the operating direction.

In the arrangement of the electrode patterns (touch sensitive patterns), the lowermost electrode P1 and the electrode P2 adjoining an upper end edge of the lowermost electrode P1 are electrically insulated from each other by a boundary line 111a formed, for example, in a generally M-like shape to realize a zigzag configuration or formation. Namely, the boundary line 111a extends zigzag, obliquely relative to the operating direction, in a transverse or width direction of the substrate 111. Thus, upper sharp apex portions of the electrode P1 bite into between lower sharp apex portions of the electrode P2. Namely, the upper sharp apex portions of the electrode P1 and the lower sharp apex portions of the electrode P2 laterally overlap with each other (i.e., overlap with each other in a direction transverse to the operating direction). Because the two adjoining electrodes P1 and P2 laterally overlap with each other like this, a user's finger put on a given operated position of the fader sensor Fd simultaneously contacts or touches the two adjoining electrodes P1 and P2.

Similarly, a boundary line 111b electrically insulating between the electrode P2 and the electrode P3 adjoining an upper end region of the electrode P2 is also formed, for example, in a generally M-like shape to realize a zigzag formation, so that upper sharp apex portions of the electrode P2 and lower sharp apex portions of the electrode P3 laterally overlap with each other. Further, a boundary line 111c electrically insulating between the electrode P3 and the electrode P4 adjoining an upper end region of the electrode P3 is also formed, for example, in a generally M-like shape to realize a zigzag formation, so that upper sharp apex portions of the electrode P3 and lower sharp apex portions of the electrode P4 laterally overlap with each other. Further, a boundary line 111d electrically insulating between the electrode P4 and the electrode P5 adjoining an upper end region of the electrode P4 is also formed, for example, in a generally M-like shape to realize a zigzag formation, so that upper sharp apex portions of the electrode P4 and lower sharp apex portions of the electrode P5 laterally overlap with each other. Furthermore, a boundary line 111e electrically insulating between the electrode P5 and the electrode P6 adjoining an upper end region of the electrode P5 is also formed, for example, in a generally M-like shape to realize a zigzag formation, so that upper sharp apex portions of the electrode P5 and lower sharp apex portions of the electrode P6 laterally overlap with each other.

As an example, the aforementioned boundary lines 111a to 111e are each symmetrical with respect to a vertical, centerline of the fader sensor extending along the operating direction. Thus, each of the patterns of the electrodes P1 to P6 (electrode patterns or touch sensitive patterns) is also symmetrical with respect to the vertical centerline, and each pair of the adjoining electrodes laterally overlap with each other. Thus, when the user touches the fader sensor Fd with a finger, the finger simultaneously touches a plurality of (preferably at least three) of the electrodes in most part, except the lower and upper ends, of the fader sensor Fd no matter which position the finger touches. Then, detection output signals indicative of finger touch states of all of the electrodes P1 to P6, including the electrodes currently touched by the user's finger, are obtained from the individual electrodes P1 to P6, so that the position (current operated position) touched by the user's finger on the touch sensor (fader sensor Fd) is determined on the basis of a combination of the detection output signals of the electrodes P1 to P6. With the aforementioned zigzag arrangement of the touch sensitive sensors (electrode patterns), operated position information can be obtained with a finer resolution than the number of the electrodes of the touch sensor (fader sensor Fd), as will be described later in greater detail.

A detection circuit 112a is connected to the electrode P1, and a level signal corresponding to a finger touch state of the electrode P1 is output from the detection circuit 112a. Similarly, detection circuits 112b, 112c, 112d, 112e and 112f are connected to the electrodes P2, P3, P4, P5 and P6, respectively, so that level signals corresponding to respective finger touch states of the electrodes P2, P3, P4, P5 and P6 are output from the detection circuits 112b to 112f. Each of the detection circuits 112a to 112f is supplied with a pulse signal from an oscillator (OSC) 114, and level signals corresponding to the finger touch states of the electrodes P1 to P6, output from the detection circuits 112a to 112f, are supplied to an arithmetic operation circuit (arithmetic operation section) 113, on the basis of which the arithmetic operation circuit 113 calculates a position of the finger having touched the fader sensor Fd and outputs the calculated position as a sensor output. More specifically, when the user's finger 110 touches the fader sensor Fd as shown in FIG. 3, it simultaneously touches three electrodes P3, P4 and P5. In such a case, level signals of levels corresponding to areas the finger 110 is touching the electrodes P3, P4 and P5 are output from the detection circuits 112c, 112d and 112e connected to the electrodes P3, P4 and P5. Meanwhile, level signals of almost zero levels are output from the detection circuits 112a, 112b and 112f connected to the electrodes P1, P2 and P6 that have not been touched by the finger 110. The level signals from the detection circuits 112a to 112f are supplied to the arithmetic operation circuit 113, where a weighted average is calculated using all of the supplied level signals. In the calculation of the weighted average, the level signals from the detection circuits 112a to 112f are multiplied by respective weighting coefficients corresponding to arranged order (i.e., positions in the arrangement) of the electrodes P1 to P6. Thus, the weighted average calculated by the arithmetic operation circuit 113 becomes a sensor output indicating which position of the fader sensor Fd the finger 110 has touched.

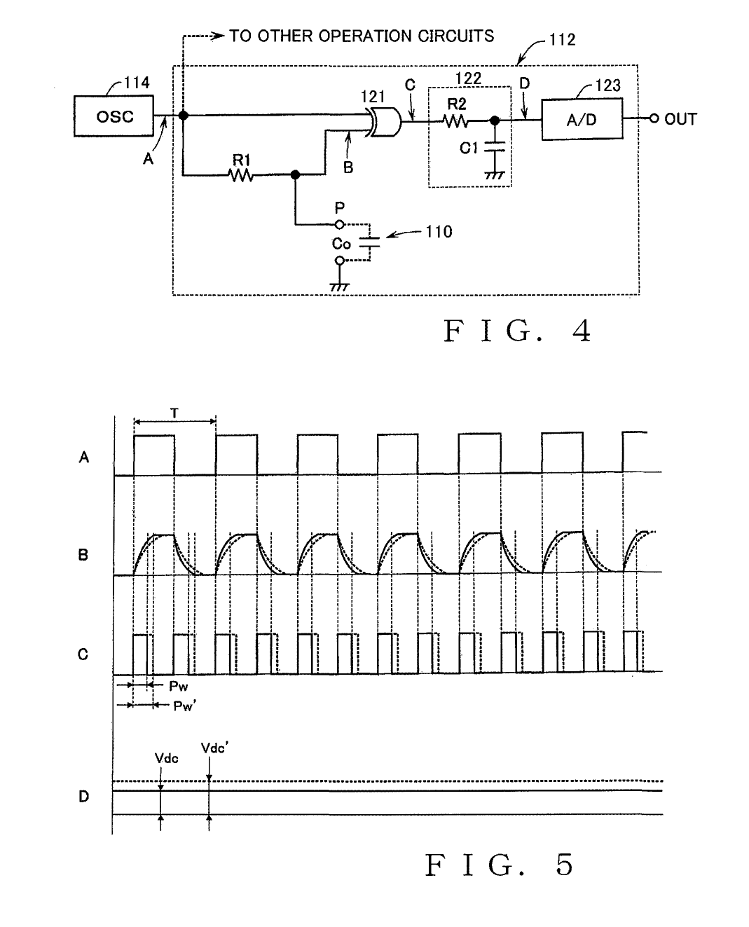

The detection circuits 112a to 112f are similar in construction, and so, FIG. 4 shows an example construction of a representative one of the detection circuits 112 and FIG. 5 shows signal waveforms of various sections of the detection circuit 112. The touch sensing by the detection circuit 112 is based on the conventionally-known variable electrostatic capacitance detection principle, which generates an output signal corresponding to electrostatic capacitance between a part of a user's body (typically a finger 110) and the electrode P.

A rectangular wave pulse A of a period T shown in A of FIG. 5 is supplied from the oscillator (OSC) 114 to the detection circuit 112. This pulse A is input not only to a first input of an exclusive OR gate (EX-OR) 121, but also to a second input of the EX-OR 121 via a resistance R1. The same pulse A is also supplied to the other detection circuits. Any one of the electrodes P of the fader sensor Fd is connected to a connection point between the resistance R1 and the second input of the EX-OR 121. Once the finger 110 touches the electrode P, the electrode P is grounded via an equivalent electrostatic capacitance Co of the finger 110. Then, the pulse A passing through the route of the resistance R1 rises and falls with a delay according to a time constant of the resistance R1 and the electrostatic capacitance Co, as indicated by broken-line rising and falling edges in B of FIG. 5. Namely, the pulse A is delayed according to the time constant of the resistance R1 and the electrostatic capacitance Co, so that the resultant delayed pulse B is input to the second input of the EX-OR 121.

Consequently, a pulse a pule C of a pulse width Pw corresponding to the delay time of the pulse B as shown in C of FIG. 5 is output from the EX-OR 121. Such pulses C are generated in synchronism with the rising edge and falling edge of each of the pulses A, and thus, the pulses C are generated at a frequency twice as high as the pulses A. The pulses C are rectified or converted into a DC wave by a low-pass filter (LPF) 122, so that the DC wave is supplied to an A/D converter 123. In the LPF 122 comprising a resistance R2 and a capacitor (C2, a time constant of the resistance R2 and the capacitor C2 is set considerably greater than the above-mentioned period T. Thus, a level signal Vdc rectified in correspondence to the pulse with Pw of the pulse C as shown in D of FIG. 5 is output from the LPF 122. The level signal Vdc is a signal corresponding to the touch state of the electrode P, and a value of the level signal corresponds to an area over which the finger 110 is touching the electrode P (i.e., touch area of the finger 110 touching the electrode P).

If the touch area of the finger 110 touching the electrode P increases, for example, due to variation of pressing force of the finger 110 on the electrode P, the equivalent electrostatic capacitance Co of the finger 110 increases, so that the pulse B to be input to the second input of the EX-OR 121 is delayed as indicated by broken line in B of FIG. 5. Thus, the pulse width Pw of the pulse C corresponding to the delay time of the pulse B increases to Pw′ as indicated by broken line in C of FIG. 5, so that the pulse C of the increased pulse width Pw′ is output from the EX-OR 121. The pulse C of the increased pulse width Pw′ is rectified by the LPF 122, but a level signal Vdc′ of the pulse C of the increased pulse width Pw′ becomes greater than the level signal Vdc because the increased pulse width Pw′ is greater than the pulse width Pw. Conversely, if the touch area of the finger 110 touching the electrode P decreases, for example, due to variation of pressing force of the finger 110 on the electrode P, the equivalent electrostatic capacitance Co of the finger 110 decreases, so that the delay amount of the pulse B to be input to the second input of the EX-OR 121 decreases. Thus, the pulse width Pw of the pulse C corresponding to the delay time of the pulse B decreases, so that the pulse C of the decreased pulse width is output from the EX-OR 121. The pulse C of the decreased pulse width is rectified by the LPF 122, but a level signal of the pulse C of the decreased pulse width becomes smaller than the level signal Vdc because the decreased pulse width is smaller than the pulse width Pw. In this manner, a level signal of a level corresponding to the touch area of the finger 110 touching the electrode P is output from the LPF 122.

The A/D converter 123 converts the analog level signal, input from the LPF 122, into a digital level signal of 16 bits including a sign bit. The digital level signal thus output from the detection circuit 112 is supplied to the arithmetic operation circuit 113.

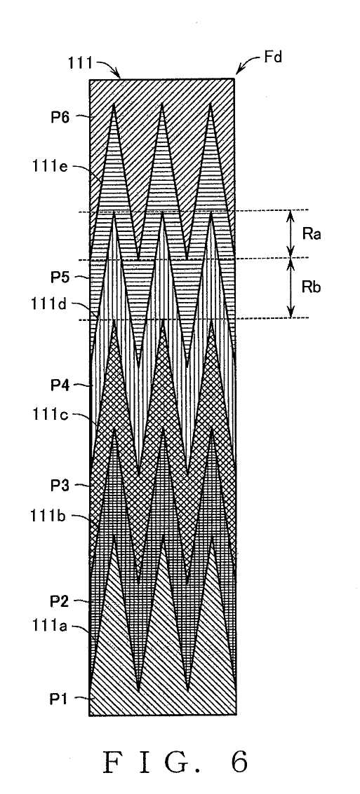

Now, with reference to FIG. 6 which shows a detailed construction of the electrodes of the fader sensor Fd, a more detailed description will be given about the fader sensor Fd.

The respective electrode patterns of the six electrodes P1 to P6 are formed on one surface of the substrate 111 of an elongated rectangular shape. The electrode patterns are each formed in a transverse zigzag configuration such that a finger 110 of the user can simultaneously touch a plurality of (preferably at least three) of the electrode patterns when the finger touches the fader sensor Fd. Preferably, each of the electrode patterns is formed to extend in the transverse or width direction in a zigzag or generally M-like shape that is symmetrical with respect to the longitudinal centerline extending along the operating direction, and each of the electrode patterns is formed in such a manner that there exists a transverse partial region Ra (only one such transverse partial region Ra is shown in the figure for clarity) where the electrode pattern laterally overlaps with two other electrode patterns located immediately above and below that electrode pattern or adjoining upper and lower end regions of that electrode pattern. For example, in the transverse partial region Ra in FIG. 6, upper apex portions of the electrode pattern of the electrode P4 adjoining a lower end region of the electrode pattern of the electrode P5 and lower apex portions of the electrode pattern of the electrode P6 adjoining an upper end region of the electrode pattern of the electrode P5 laterally overlap with the electrode pattern of the electrode P5. Likewise, each of the electrode patterns of the electrodes P2 to P4 is formed to extend in the transverse or width direction in a zigzag or generally M-like shape in such a manner that there exists a transverse partial region Ra where the electrode pattern laterally overlaps with two other electrode patterns located immediately above and below that electrode pattern or adjoining upper and lower end regions of that electrode pattern. In the illustrated example of FIG. 6, the number of electrode patterns laterally overlapping with each other in a transverse partial region Rb located immediately below or above the partial region Ra is two. Note however that the area over which the finger 110 touches the fader sensor Fd exceeds a dimension, in a height direction (vertical dimension as viewed in FIG. 6), of the region Rb as shown in FIG. 3. Thus, when the finger 110 touches the fader sensor Fd, it touches the electrode patterns of at least three of the electrodes P1 to P6. Note, however, that the present invention is never intended to be limited to such an arrangement.

In the illustrated example of FIG. 6 too, the electrode pattern of each of the electrodes P1 and P6, located at opposite (lower and upper) ends of the fader sensor Fd, has an adjoining electrode pattern only on one (upper or lower) side thereof; thus, the electrode pattern of each of the electrodes P1 and P6 overlaps with the adjoining electrode pattern only on the one side thereof. Thus, when the finger 110 touches an upper end or lower end region of the fader sensor Fd, it may actually touch only two other electrode patterns.

As a modification, the touch sensor (fader sensor Fd) may be constructed in such a manner that the finger can simultaneously touch two or more electrode patterns (touch sensitive patterns) at a given operated position on the touch sensor (fader sensor Fd) but can simultaneously touch only one electrode pattern (touch sensitive pattern) at another operated position on the touch sensor (fader sensor Fd).

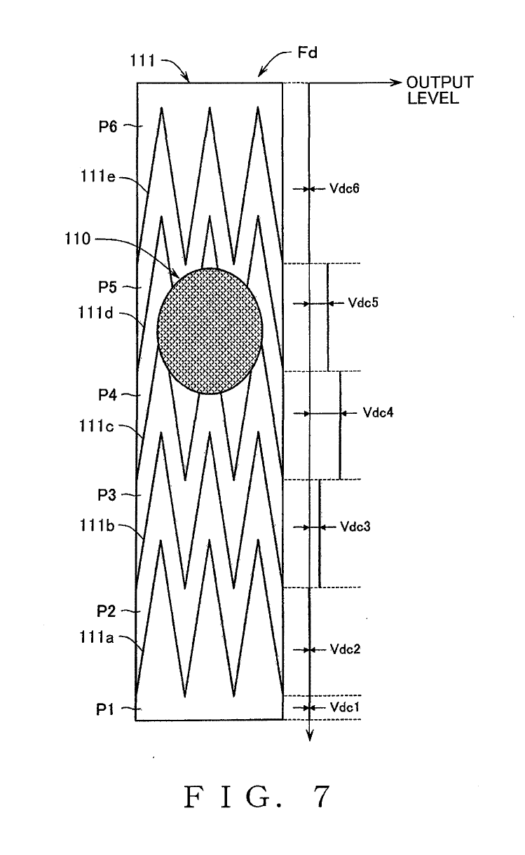

Let's now consider a case where the finger 110 has touched the fader sensor Fd, having the electrode patterns of the electrodes P1 to P6 formed thereon, in a manner as shown in FIG. 7. In this case, the finger 110 simultaneously touches three electrodes P3, P4 and P5, so that the detection circuits 112c to 112e connected to the electrodes P3, P4 and P5 output level signals Vdc3, Vdc4 and Vdc5, respectively, corresponding to finger touch states of the electrodes P3, P4 and P5. Because the area over which the finger 110 is touching the electrode P4 is the greatest, the level signal Vdc4 output from the detection circuit 112d of the electrode P4 has the greatest level. Further, because the area over which the finger 110 is touching the electrode P5 is the second greatest, the level signal Vdc5 output from the detection circuit 112e of the electrode P5 has the second greatest level. Furthermore, because the area over which the finger 110 is touching the electrode P3 is the smallest, the level signal Vdc3 output from the detection circuit 112c of the electrode P3 has the smallest level. Further, the detection circuits 112a, 112b and 112f of the electrodes P1, P2 and P6 that are not being touched by the finger 110 each output a level signal of an almost zero level.

The arithmetic operation circuit 113, to which are input the level signals Vdc1 to Vdc6 from all of the detection circuits 112a to 112f, calculates a position PS of the finger 110 having touched the fader sensor Fd by a weighted average calculation method as indicated by Mathematical Expression (1) below.

PS=(m1×Vdc1+m2×Vdc2+m3×Vdc3+m4×Vdc4+m5×Vdc5+m6×Vdc6)/(Vdc1+Vdc2+Vdc3+Vdc4+Vdc5+Vdc6). (1)

In Mathematical Expression (1) above, Vdc1 to Vdc6 represent the level signals output from the detection circuits 112a to 112f, respectively, and m1 to m6 represent weighting coefficients, corresponding to the arranged order (positions in the arrangement) of the electrodes, that are multiplied to the level signals Vdc1 to Vdc6, respectively. The weighting coefficients m1 to m6 are, for example, example, “0”, “1”, “2”, “3”, “4” and “5”, although they are not so limited.

If each of the level signals Vdc1 to Vdc6 is a signal of 16 bits including a sign bit, then the arithmetic operation circuit 113 performs 16-bit arithmetic operations, but a sensor output generated from the arithmetic operation circuit 113, indicative of the position PS of the fader sensor Fd touched by the finger, is rounded to 7 bits (0 to 127). Thus, in the case where the fader sensor Fd has six electrodes P1 to P6 as noted above, the position PS of the finger 110 having touched the fader sensor Fd has a resolution of 128/6 times, so that a high-resolution sensor output can be provided. Note that, of the sensor outputs of “0” to “127”, the minimum value “0” corresponds to the position of the lowermost electrode P1 while the maximum value “127” corresponds to the position of the uppermost electrode P6. Namely, the positions of the lowermost electrode P1 to the uppermost electrode P6 can be indicated by the values of “0” to “127”. Further, because the patterns of the electrodes P1 to P6 each have a transverse zigzag shape with respect to the longitudinal operating direction, the sensor output will indicate generally the same value even when the finger having touched the fader sensor Fd positionally shifts laterally as along as the lateral shift does not involve any change in position in the one-dimensional operating direction from the lowermost electrode P1 (i.e., the lateral shift maintains a same transverse position relative to the one-dimensional operating direction).

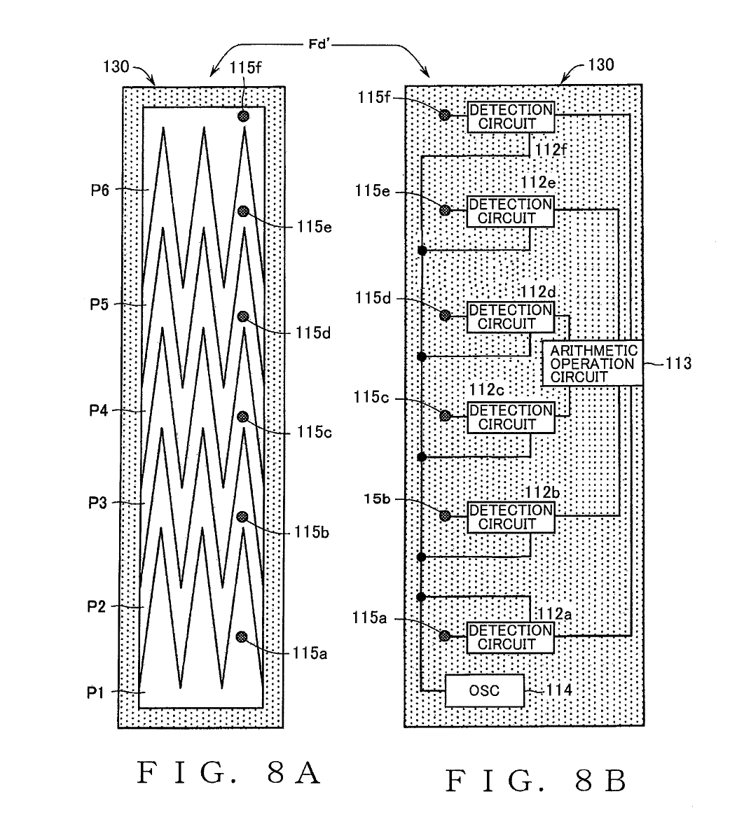

FIGS. 8A and 8B show an example specific construction of another embodiment where the fader sensor Fd and sensor circuitry shown in FIG. 3 are provided on the front surface and back surface of a single substrate 130; in FIGS. 8A and 8B, the fader sensor is indicated by Fd′. More specifically, FIG. 8A shows a construction of the front surface of the substrate 130, while FIG. 8B shows a construction of the back surface of the substrate 130. As shown in FIG. 5A, patterns of the electrodes P1 to P6 each having the same shape as shown in FIG. 3 are formed on the front surface of the substrate 130 with a peripheral margin. A through-hole 115a is formed in a side portion (right side position in FIG. 8A) of the electrode pattern of the electrode P1. Similarly, through-holes 115b to 115f are formed in respective side portions (right side positions in FIG. 8A) of the electrode patterns of the electrodes P2 to P6. Further, on the back surface of the substrate 30, the detection circuits 112a to 112f each in the form of an integrated circuit are arranged in corresponding relation to the electrodes P1 to P6 fined on the front surface. Further, respective input terminals of the detection circuits 112a to 112f are connected to the corresponding electrodes P1 to P6 via patterns formed on the back surface and the through-holes 115a to 115f.

Further, the oscillator (OSC) 114 in the form of an integrated circuit is provided on the back surface of the substrate 130, and an output of the OSC 114 is connected to pulse input terminals of the detection circuits 112a to 112f via patterns formed on the back surface of the substrate 130. Thus, a pulse output from the OSC 114 is supplied to the detection circuits 112a to 112f, but also the electrodes P1 to P6 are connected to the input terminals of the detection circuits 112a to 112f. Further, respective output terminals of the detection circuits 112a to 112f are connected to input terminals of the arithmetic operation circuit 113, which is also an integrated circuit formed on the back surface of the substrate 130, via patterns formed on the back surface of the substrate 130. Thus, level signals Vdc1 to Vdc6 output from the detection circuits 112a to 112f are supplied to the arithmetic operation circuit 113, where the weighted average calculation method indicated by Mathematical Expression (1) above is performed so that a position PS of the finger 110 having touched the fader sensor Fd′ is detected with a high resolution.

By the electrode patterns and sensor circuitry, comprising the detection circuits, OSC and arithmetic operation circuit 113, provided on the front and back surfaces of the substrate 130, a compact construction of the fader sensor Fd′ suited for incorporation in a small-size external remote controller can be realized.

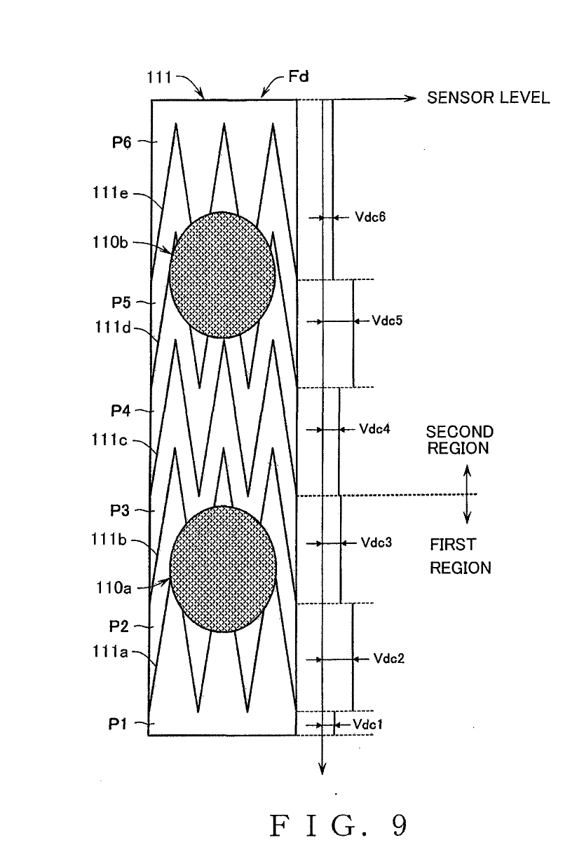

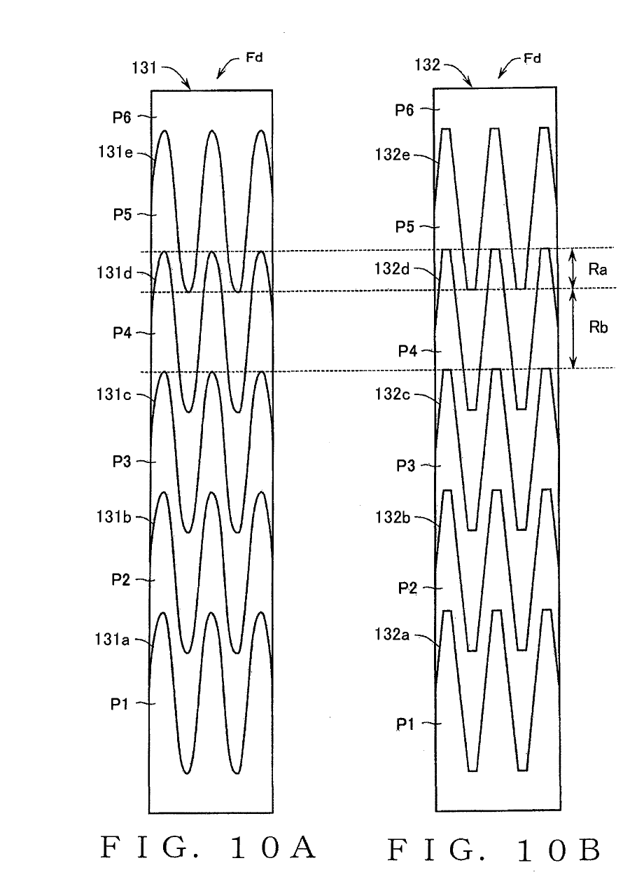

FIG. 9 shows example behavior of the touch sensor (fader sensor Fd) when a plurality of positions on the touch sensor (fader sensor Fd) has been simultaneously touched by the user. Namely, when two fingers of the user have touched the fader sensor Fd, the embodiment of the fader sensor Fd can detect that two fingers of the user have touched the fader sensor Fd and thereby generates sensor outputs indicative of positions on the fader sensor Fd touched by the two fingers. The following describe, with reference to FIG. 9, how the fader sensor Fd can detect that two fingers of the user have touched the fader sensor Fd and thereby generates sensor outputs indicative of positions on the fader sensor Fd touched by the two fingers.

Let it be assumed here that two fingers 110a and 110b have simultaneously touched the fader sensor Fd. In this case, the finger 110a simultaneously touches three electrodes P1, P2 and P3, so that level signals Vdc1, Vdc2 and Vdc3 corresponding to finger touch states of the electrodes P1, P2 and P3 are output from the detection circuits 112a to 112c connected to the electrodes P1, P2 and P3. Meanwhile, the finger 110b simultaneously touches three electrodes P4, P5 and P6, so that level signals Vdc4, Vdc5 and Vdc6 corresponding to finger touch states of the electrodes P4, P5 and P6 are output from the detection circuits 112d to 112f connected to the electrodes P4, P5 and P6.

Further, because the area over which the finger 110a is touching the electrode pattern of the electrode P2 is great, the level signal Vdc2 output from the detection circuit 112b of the electrode P2 has a great level. Likewise, because the area over which the finger 110b is touching the electrode pattern of the electrode P5 is great, the level signal Vdc5 output from the detection circuit 112e of the electrode P5 has a great level. Further, because the areas over which the fingers 110a and 110b are touching the electrode patterns of the electrodes P3 and P4 are also considerably great, the level signals Vdc3 and Vdc4 output from the detection circuits 112c and 112d of the electrodes P3 and P4 each have a considerably great level. Furthermore, because the areas over which the fingers 110a and 110b are touching the electrode patterns of the electrodes P and P6 are small, the level signals Vdc1 and Vdc6 output from the detection circuits 112a and 112f of the electrodes P1 and P6 each have a small level.

When the two fingers 110a and 110b are simultaneously touching the fader sensor Fd as shown in FIG. 9, the number of the electrodes of which level signals are output increases as compared to when only one finger is touching the fader sensor Fd. Further, it can be seen that a variance value of the level signals Vdc1 to Vdc6 from the detection circuits 112a to 112f, which is calculated by the arithmetic operation circuit 113 in the case where the two fingers 110a and 110b are simultaneously touching the fader sensor Fd as shown in FIG. 9, is greater than a variance value of the level signals Vdc1 to Vdc6 calculated by the arithmetic operation circuit 113 in the case where only one finger 110 is simultaneously touching the fader sensor Fd as shown in FIG. 3.

Based on the variance value calculated by the arithmetic operation circuit 113 as above, it is possible to determine whether only one finger has touched the fader sensor Fd or two fingers have simultaneously touched the fader sensor Fd. Namely, the arithmetic operation circuit 113 calculates a variance value of the level signals Vdc1 to Vdc6 output from the detection circuits 112a to 112f. If the thus-calculated variance value is smaller than a predetermined value, the arithmetic operation circuit 113 can determine that only one finger has touched the fader sensor Fd, while, if the thus-calculated variance value is greater than the predetermined value, the arithmetic operation circuit 113 can determine that two fingers have touched the fader sensor Fd. Thus, in this case, the arithmetic operation circuit 113 functions as a determination section that, from a distribution of touch detection output signals of the individual electrode patterns, determines whether only one finger has touched the touch sensor (fader sensor Fd) or two fingers have touched the touch sensor. Note that the variance value SC can be calculated by

SC=sum of [{(level signal Vdc1−average value of level signals)²},{(level signal Vdc2−average value of level signals)²},{(level signal Vdc3−average value of level signals)²},{(level signal Vdc4−average value of level signals)²},{(level signal Vdc5−average value of level signals)²} and {(level signal Vdc6−average value of level signals)²}]÷number of level signals

If the arithmetic operation circuit 113 determines that only one finger has touched the fader sensor Fd, then it calculates a position PS of the one finger having touched the fader sensor Fd through the weighted average calculation method indicated by Mathematical Expression (1) above.

Further, if the arithmetic operation circuit 113 determines that two fingers have touched the fader sensor Fd, then it divides the touch sensitive patterns (electrode patterns) of the fader sensor Fd of FIG. 9 into a lower or first region (first group) and an upper or second region (second group), and it calculates, for each of the divided regions, a position of one of the fingers having touched the fader sensor Fd through the weighted average calculation method. Here, the arithmetic operation circuit 113 effects the pattern division into the regions, for example, by allocating a substantially equal number of the touch sensitive patterns (electrode patterns) to each of the first region (first group) and second region (second group). Namely, in the illustrated example, the first region (first group) comprises the electrode patterns P1 to P3, while the second region (second group) comprises the electrode patterns P4 to P6. In this case, the arithmetic operation circuit 113 calculates a position PS1 of the finger 110a, having touched the first region, through a weighted average calculation method using Mathematical Expression (2) below.

PS1=(m1×Vdc1+m2×Vdc2+m3×Vdc3)/(Vdc1+Vdc2+Vdc3) (2)

In Mathematical Expression (2), Vdc1 to Vdc3 represent level signals output from the detection circuits 112a to 112c connected to the electrodes P1 to P3, m1 to m3 represent weighting coefficients, corresponding to the arranged order (positions in the arrangement) of the electrodes P1 to P3, that are multiplied to the level signals Vdc1 to Vdc3, respectively. The weighting coefficients m1 to m3 are, for example, “0”, “1” and “2”, although they are not so limited.

Further, the arithmetic operation circuit 113 calculates a position PS2 of the finger 110b, having touched the second region, through a weighted average calculation method using Mathematical Expression (3) below.

PS2+(m4×Vdc4+m5×Vdc5+m6×Vdc6)/(Vdc4+Vdc5+Vdc6) (3)

In Mathematical Expression (3), Vdc4 to Vdc6 represent level signals output from the detection circuits 112d to 112f connected to the electrodes P4 to P6, m4 to m6 represent weighting coefficients, corresponding to the arranged positions of the electrodes P4 to P6, that are multiplied to the level signals Vdc4 to Vdc6, respectively. The weighting coefficients m4 to m6 are, for example, “0”, “1” and “2”, although they are not so limited.

Here, If each of the level signals Vdc1 to Vdc6 is a signal of 16 bits including a sign bit, then the arithmetic operation circuit 113 performs 16-bit arithmetic operations, but sensor outputs generated from the arithmetic operation circuit 113, indicative of position PS1 and PS2 of the fader sensor Fd touched by the fingers 110a and 110b, are each rounded to 7 bits (0 to 127). Thus, in the case where the fader sensor Fd has six electrodes P1 to P6 as noted above, the position PS1 and PS2 of the fader sensor Fd touched by the fingers 110a and 110b each have a resolution of 128/6 times, so that high-resolution sensor outputs can be provided.

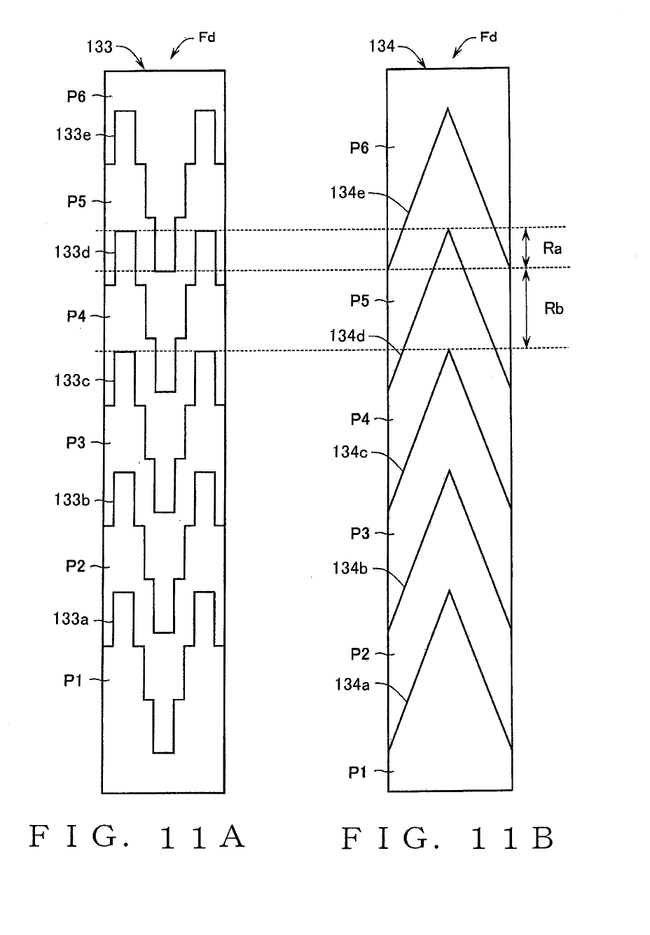

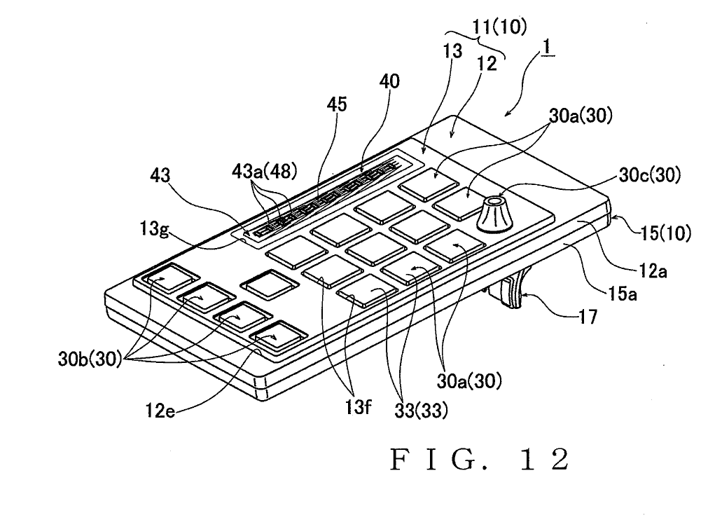

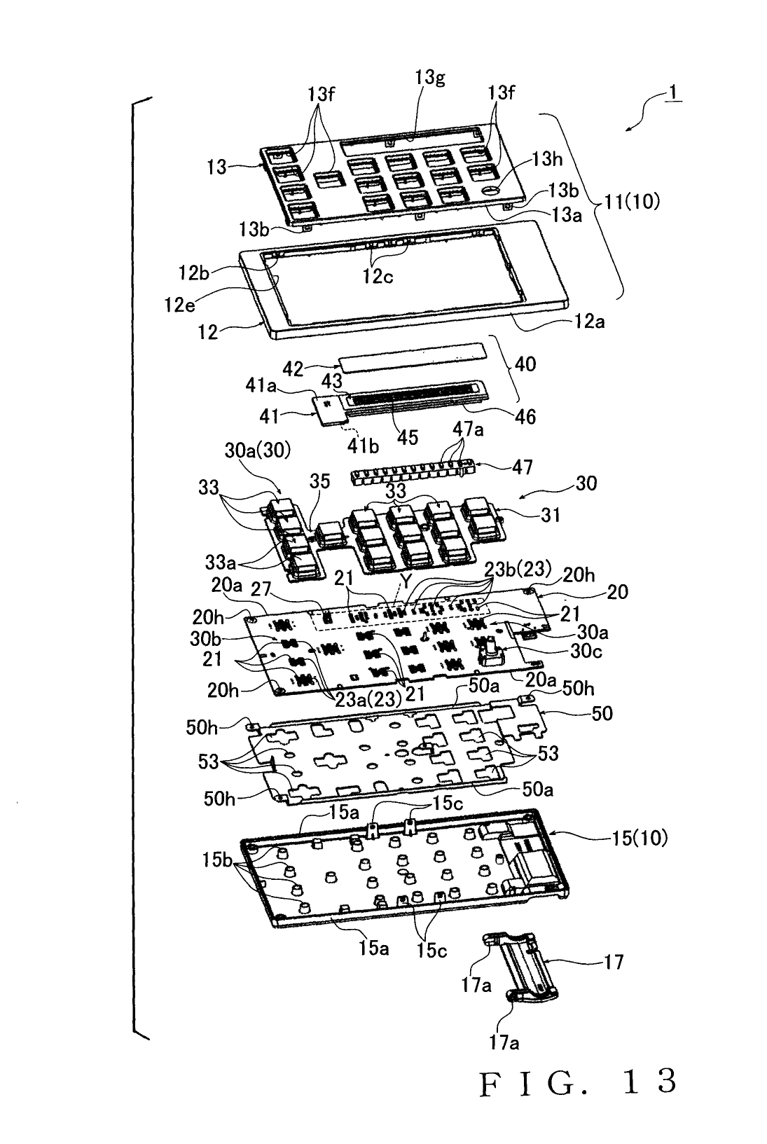

In the fader sensor Fd of the present invention, as noted above, the arithmetic operation circuit 113 first calculates a variance value of the level signals Vdc1 to Vdc6, output from the detection circuits 112a to 112f, to determine whether one finger has touched the fader sensor Fd or two fingers have simultaneously touched the fader sensor Fd, then divides the region of the touch sensitive patterns (electrode patterns) into two regions to perform arithmetic operations of the weighted average calculation method on each of the divided regions and thereby calculate a position of the fader sensor touched by the finger in the divided region.

Whereas, in the above-described embodiment, the zigzag boundary between each pair of adjoining touch sensitive patterns P1 to P6 is of a generally M-like shape or sharp triangular wave shape, the present invention is not so limited, and the zigzag boundary between each pair of adjoining touch sensitive patterns P1 to P6 may be modified as shown in FIGS. 10A to 11B.

In the modified example of FIG. 10A, the zigzag boundary between each pair of adjoining touch sensitive patterns is formed to extend in the transverse or width direction in a sine wave shape. Namely, the electrode patterns of the six electrodes P1 to P6 are formed on a substrate 131 of the fader sensor Fd, and boundaries 131a, 131b, 131c, 131d and 131e between pairs of adjoining electrode patterns are each of a sine wave shape symmetrical with respect to the longitudinal axis. Thus, the electrode pattern of each of the six electrodes P1 to P6 too is of a sine wave shape symmetrical with respect to the longitudinal axis, and upper apex portions of one electrode pattern bite into between lower apex portion of another electrode pattern adjoining the upper end region of the one electrode pattern while lower apex portions of the one electrode pattern bite into between upper apex portions of another electrode pattern adjoining the lower end region of the one electrode pattern. Thus, the electrode patterns each having a sine wave shape are arranged in such a manner that three of them laterally overlap with one another in a transverse partial region Ra (only one such transverse partial region Ra is shown in the figure).

In the modified example of FIG. 10B, the zigzag boundary between each pair of adjoining touch sensitive patterns is formed to extend in the transverse or width direction in a repeated-trapezoid shape. Namely, the electrode patterns of the six electrodes P1 to P6 are formed on a substrate 132 of the fader sensor Fd, and boundaries 132a, 132b, 132c, 132d and 132e between pairs of adjoining electrode patterns are each of a repeated-trapezoid shape and symmetrical with respect to the longitudinal axis. Thus, the electrode pattern of each of the six electrodes P1 to P6 too is formed in a repeated-trapezoid shape symmetrical with respect to the longitudinal axis, and upper apex portions of one electrode pattern bite into between lower apex portion of another electrode pattern adjoining the upper end region of the one electrode pattern while lower apex portions of the one electrode pattern bite into between upper apex portions of another electrode pattern adjoining the lower end region of the one electrode pattern. Thus, the electrode patterns each having a repeated-trapezoid shape are arranged in such a manner that three of them laterally overlap with one another in each transverse partial region Ra (only one such horizontal partial region Ra is shown in the figure).

Further, in the modified example of FIG. 11A, the zigzag boundary between each pair of adjoining touch sensitive patterns is formed to extend in the transverse direction in a stepwise shape. Namely, the electrode patterns of the six electrodes P1 to P6 are formed on a substrate 133 of the fader sensor Fd, and boundaries 133a, 133b, 133c, 133d and 133e between pairs of adjoining electrode patterns are each of a stepwise shape and symmetrical with respect to the longitudinal axis. Thus, the electrode pattern of each of the six electrodes P1 to P6 too is formed in a stepwise shape symmetrical with respect to the longitudinal axis, and upper apex portions of one electrode pattern bite into between lower apex portion of another electrode pattern adjoining the upper end region of the one electrode pattern while lower apex portions of the one electrode pattern bite into between upper apex portions of another electrode pattern adjoining the lower end region of the one electrode pattern. Thus, the electrode patterns each having a stepwise shape are arranged in such a manner that three of them laterally overlap with one another in each transverse partial region Ra (only one such transverse partial region Ra is shown in the figure).

Furthermore, in the modified example of FIG. 11B, the zigzag boundary between each pair of adjoining touch sensitive patterns is formed in a generally triangular shape. The electrode patterns of the six electrodes P1 to P6 are formed on a substrate 134 of the fader sensor Fd, and boundaries 134a, 134b, 134c, 134d and 134e between pairs of adjoining electrode patterns are each of a generally triangular shape and symmetrical with respect to the longitudinal axis. Thus, the electrode pattern of each of the six electrodes P1 to P6 too is formed in a generally triangular shape symmetrical with respect to the longitudinal axis, and upper apex portions of one electrode pattern bite into between lower apex portion of another electrode pattern adjoining the upper end region of the one electrode pattern while lower apex portions of the one electrode pattern bite into between upper apex portions of another electrode pattern adjoining the lower end region of the one electrode pattern. Thus, the electrode patterns each having a generally triangular shape are arranged in such a manner that three of them laterally overlap with one another in each transverse partial region Ra (only one such transverse partial region Ra is shown in the figure).

In each of the aforementioned fader sensors Fd of FIGS. 10A, 10B, 11A and 11B, where the electrode patterns are each formed transversely symmetrically with respect to the vertical center axis, a user's finger touches at least three of the electrodes P1 to P6 when the finger touches the fader sensor Fd. Note that, whereas the number of the laterally-overlapping electrode patterns in each of the transverse partial regions Rb located immediately above and beneath the transverse partial region Ra is two in each of the fader sensors Fd, the area over which the finger touches the fader sensor Fd exceeds a height dimension (vertical dimension in the figure) of the transverse partial region Rb. Thus, as the user touches the fader sensor Fd with a finger, the finger touches the patterns of at least three of the electrodes P1 to P6. Further, because the electrodes P1 to P6 are each formed transversely symmetrically with respect to the longitudinal axis, the sensor output will indicate generally the same value even when the finger having touched the fader sensor Fd positionally shifts laterally, as along as the lateral shift does not involve any change in position in the one-dimensional operating direction from the lowermost electrode P1 (i.e., the lateral shift maintains a same transverse position relative to the one-dimensional operating direction).

In each of the aforementioned fader sensors Fd of FIGS. 10A, 10B, 11A and 11B too, the electrode pattern of each of the electrodes P1 and P6, provided at the opposite ends of the fader sensor Fd, has an adjoining electrode pattern only on one (upper or lower) side thereof; thus, the electrode pattern of each of the electrodes P1 and P6 overlaps with the adjoining electrode pattern only on one (upper or lower) side thereof. Thus, when the finger touches an upper end or lower end region of the fader sensor Fd, it may actually touch only two electrode patterns.

Whereas the arithmetic operation circuit 113 has been described as calculating a variance value of the level signals Vdc1 to Vdc6 output from the detection circuits 112a to 112f and determining, in accordance with the calculated variance value, whether only one finger has touched the fader sensor Fd or two fingers have simultaneously touched the fader sensor Fd. Alternatively, the arithmetic operation circuit 113 may determine, in accordance with a calculated standard deviation value rather than the variance value, whether only one finger has touched the fader sensor Fd or two fingers have simultaneously touched the fader sensor Pd. In this case, if the thus-calculated standard deviation value is smaller than a predetermined value, the arithmetic operation circuit 113 can determine that only one finger has touched the fader sensor Fd, while, if the thus-calculated standard deviation value is greater than the predetermined value, the arithmetic operation circuit 113 can determine that that two fingers have touched the fader sensor Fd.

Further, the fader sensor Fd, which is an embodiment of the touch sensor of the present invention, has been described as constructed to adjust the fader level of the channel assigned to the fader sensor Fd in response to a human operator or user to touch the fader sensor Fd with its finger. Alternatively, the fader sensor Fd may be constructed to adjust the fader level of the channel assigned thereto in response to the user slidingly moving its finger on and along the fader sensor Fd, more particularly in accordance with an amount of the sliding movement or operation of the finger on and along the fader sensor Fd. In this case, it is only necessary that start and end positions of the sliding operation on the fader sensor Fd be detected so that an amount of the sliding movement can be calculated from a difference between the start and end positions of the sliding operation.

Further, according to the above-described embodiment, each of the touch sensitive patterns (i.e., patterns of the electrodes P1 and P6) is of the electrostatic capacitance type which generates a detection signal of a level corresponding to an area of touch of a human operator's finger on the touch sensitive pattern. Alternatively, the touch sensitive pattern may be of a pressure sensitive type which generates a detection signal of a level corresponding to contact pressure applied thereto, or may be of a type employing any other desired touch sensing principle. In short, each of the touch sensitive patterns only has to be constructed to generate a detection signal of a level corresponding to a degree (area, contact pressure or the like) of a touch on the touch sensitive pattern.

Further, the touch sensor of the present invention is applicable not only as an audio signal processing fader sensor but also as a signal processing or operated-position detecting touch sensor of any desired purpose. No matter what purpose the touch sensor of the present invention is applied to, the touch sensor of the present invention can increase the operated position detecting accuracy.

### Second Embodiment of the Controller

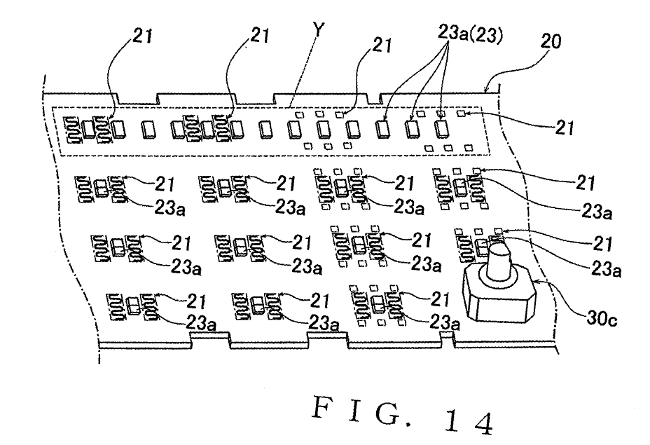

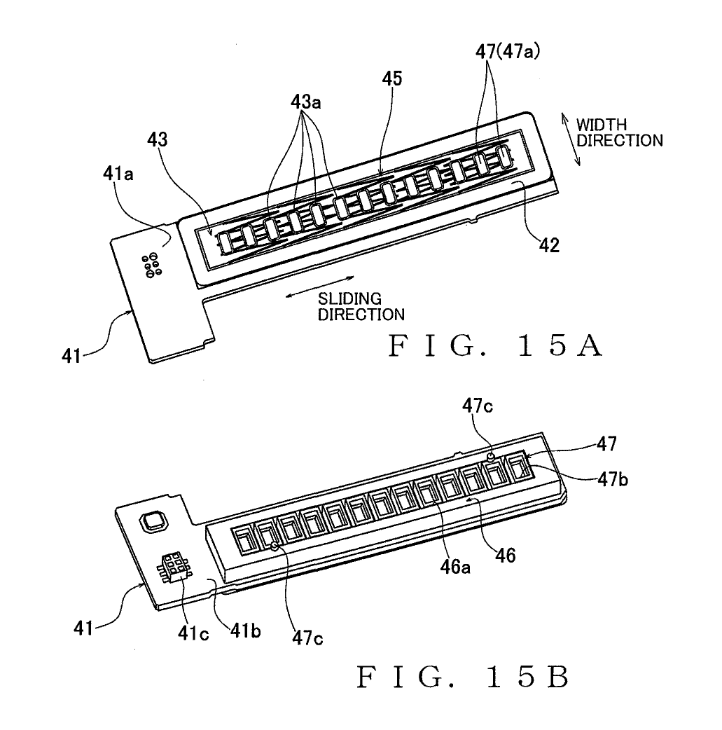

FIG. 12 is a perspective view showing an outer appearance of a music piece data input device 1 which is an embodiment of the controller of the present invention, and FIG. 13 is an exploded perspective view showing component parts of the music piece data input device 1. The music piece data input device 1 comprises, among others: an exterior casing 10 including an upper case 11 and a lower case 15; a circuit substrate (first circuit substrate) 20 provided within the exterior casing 10; a switch type controller 30 provided on the circuit substrate 20 within the exterior casing 10; and a fader type controller 40. Details of these component parts will be discussed hereinbelow.

The upper case 11 and the lower case 15 are each a flat plate member of a generally rectangular shape having peripheral walls (outer peripheral edge portions) formed of synthetic resin or the like. The outer peripheral edge portions 15a of the lower case 15 are bent upwardly, while the outer peripheral edge portions 12a of the upper case 11 (frame 12) are bent downwardly. The upper case 11 and the lower case 15 are vertically superposed on each other, and their respective outer peripheral edge portions 12a and 15a are fixedly joined with each other so that the upper case 11 and the lower case 15 are integrated together to provide the external casing 10. Within such an external casing 10 are accommodated the circuit substrate 20, switch type controller 30, fader type controller 40, a metal reinforcing plate 50, etc.

Further, a stand 17 is mounted to the underside of the lower case 15 in such a manner that it is pivotable about pivot points 17a relative to the underside of the lower case 15. As shown in FIG. 12, the music piece data input device 1 can be installed in an inclined posture or position by the stand 17 being pivoted downward from the underside of the lower case 15 to support the lower case 15 obliquely.

Further, as shown in FIG. 13, a plurality of projections 15b, each having a substantially cylindrical shape, are formed on the inner surface of the lower case 15 at positions corresponding to later-described switch contact patterns 21 provided on the circuit substrate 20. The projections 15b support, from below, the switch contact patterns 21 on the circuit substrate 20 that are depressed by fingers of a human operator or user via upwardly-projecting key top portions 33, and thus, the projections 15b have a function for preventing the circuit substrate 20 from being deformed by the user hitting the key top portions 33, and a function for preventing reduction in detection accuracy of touch outputs. Further, a plurality of projecting claw portions 15c engageable with a plurality of engagement portions 12c provided on the upper case 11 (frame 12) are formed on the inner surface of the lower case 15 near the longitudinal outer edge portion 15a.

The upper case 11 comprises two component parts: the frame (first upper case) 12 having upper edge portions 12a superposed on the outer edge portions 15a of the lower case 15; and a panel plate (second upper case) 13 of a generally flat shape disposed in an opening portion 12e formed in the frame 12. The panel plate 13 has a rectangular outer shape slightly smaller than an outer shape of the frame 12. A plurality of claw portions 13b engageable with a plurality of engagement portions 12b provided in the inner peripheral edge of the opening portion 12e of the frame 12. With such engagement portions 12b and claw portions 13b, the panel plate 13 can be snap-fit into the opening portion 12e of the frame 12. Further, the panel plate 13 has formed therein a plurality of through-holes (openings) 13f to permit exposure of respective operating surfaces (upper surfaces) 33a of the key top portions 33, a through-hole (opening) 13h to permit passage therethrough of a shaft portion of a rotary encoder 30c, and a through-hole (opening) 13g to permit exposure of a fader section (fader type touch sensor) 43 of the fader type controller 40.

Shapes, positions and numbers of the through-holes 13f, 13g and 13h formed in the panel plate 13 are chosen or set in accordance with types and numbers of the switches 30a and 30b (i.e., later-described pad type switches 30a and function selecting switches 30b), rotary encode 30c and fader type controller 40 provided on the music piece data input device 1. As product variations of the music piece data input device 1, there may be prepared a plurality of types of models differing from each other in the types, numbers, etc. of the switch type controller 30 and fader type controller 40. In such a case, the plurality of types of models may be provided by changing only the shape of the panel shape 13 while employing the same shapes of the lower case 15 and the frame 12 of the upper case 11 for the plurality of types of models. Namely, the plurality of types of models can be manufactured with a reduced number of types of component parts by changing the shape of the panel plate 13 and the constructions of the switch type controller 30 and fader type controller 40 in accordance with the plurality of types of models while employing the same or common lower case 15 and the frame 12 for the plurality of types of models.

The circuit substrate 20 is a hard substrate of a substantially rectangular flat plate shape accommodatable in the lower case 15. On the circuit substrate 20 are formed the switch contact patterns (fixed contact patterns) 21 for the switches 30a and 30b of the switch type controller 30. Also, on the rotary encoder 30c are mounted a plurality of LED elements (light emitting elements) 23. The LED elements 23 include first LED elements (first light emitting elements) 23a for the switch type controller 30 and second LED elements (second light emitting elements) 23b for the fader type controller 40. In addition, insertion holes 20h for insertion therethrough of screws (not shown) for fastening together the upper case 11 and the lower case 15 are formed in corner portions of the circuit substrate 20.

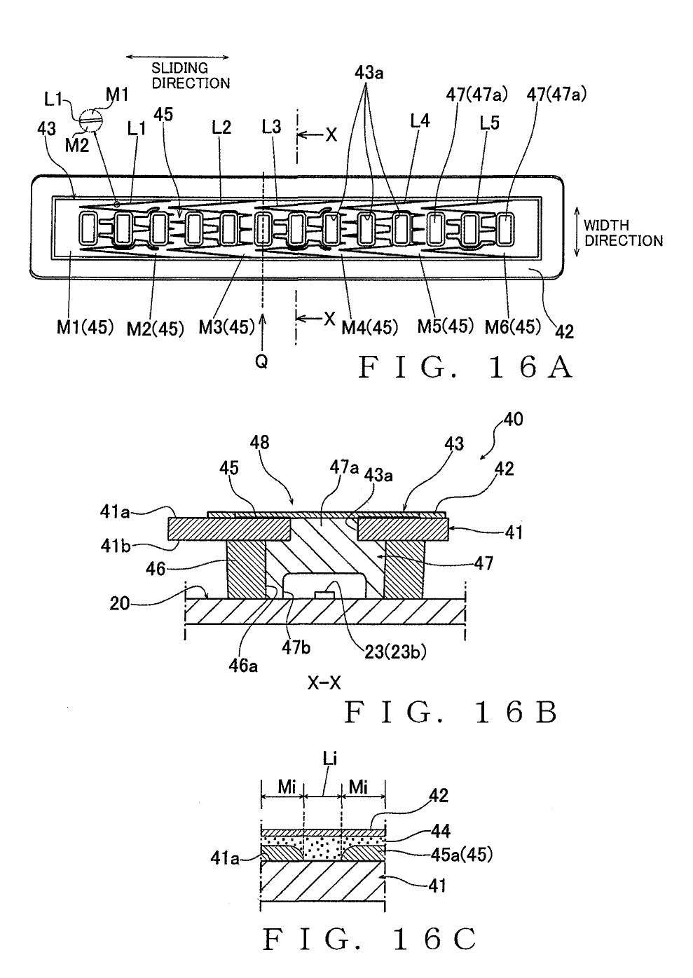

FIG. 14 is a fragmentary enlarged view of the switch contact patterns 21 and LED elements 23 provided on the circuit substrate 20. As shown in the figure, the switch contact patterns 21 are arranged on the circuit substrate 20 at predetermined intervals in a matrix configuration. Of the LED elements 23 provided on the circuit substrate 20, the first LED elements 23a for the switch type controller 30 are mounted on central regions of the individual switch contact patterns 21 (i.e., inside the individual switch contact patterns 21). Although the first LED elements 23a for the switch type controller 30 are mounted on the central regions of all the individual switch contact patterns 21 in the illustrated example of FIG. 14, such first LED elements 23a may be dispensed with in the central region of some of the switch contact patterns 21. Further, a plurality of the second LED elements (13 second LED elements in the illustrated example of FIG. 13) 23b for the fader type controller 40 are arranged in a straight-line configuration in a region (surrounded by broken line Y in FIG. 13) of the circuit substrate 20 that corresponds to a fader substrate 41.

The switch contact patterns 21 are also formed around each of some of the second LED elements 23b (in the illustrated example of FIG. 14, around each of four second LED elements 23b, i.e. first, fifth, ninth and thirteenth second LED elements 23b from the right). Such second LED elements 23b around which the switch contact patterns 21 are formed are usable also as the first LED elements 23a for the switch type controller 30. Note, however, that, in the instant embodiment of the music piece data input device 1, such LED elements 23b are used only as the second LED elements 23b for the fader type controller 40 and the switch contact patterns 21 around the second LED elements 23b are not used.

In the instant embodiment, as noted above, the switch contact patterns 21 are formed around each of some of the second LED elements 23b (four second LED elements 23b in the illustrated example), and such second LED elements 23b are usable also as the first LED elements 23a for the switch type controller 30. Thus, the above-described circuit substrate 20 is usable not only in the instant embodiment of the music piece data input device 1 including both of the switch type controller 30 and the fader type controller 40, but also in another type of music piece data input device including only the switch type controller 30 (i.e., including no fader type controller 40) that corresponds to a later-described third embodiment of the music piece data input device 1-2. The circuit substrate 20 constructed in the aforementioned manner can be shared among a plurality of types of music piece data input devices 1, which can significantly reduce the number of types of component parts and enhance a product manufacturing efficiency.

Referring back to FIG. 13, a key top piece 31 is a resin-made, flexible plate-shaped member for installation on the circuit substrate 20. The key top piece 31 integrally includes the upwardly-projecting key top portions 33 for pressing the switch contact patterns 21 provided on the circuit substrate 20, and a flexible connection section 35 of a thin plate shape interconnecting adjoining ones of the key top portions 33. Each of the key top portions 33 is in the form of a small projection of a size and shape corresponding to one of the switch contact patterns 21, and the upper surface of each of the key top portions 33 is constructed to function as an operating surface 33 operable with a user's finger or the like. Also, a depression portion (not shown) for depressing and thereby turning on the corresponding switch contact pattern 21 on the circuit substrate 20 is provided on the lower surface or underside of each of the key top portions 33. A cavity is formed centrally in the depression portion for avoiding interference with the LED element 23 provided on the circuit substrate 20.

Each of the switches 30a and 30b of the switch type controller 30 comprises the first LED element 23a provided on the circuit substrate 20, the switch contact pattern 21 formed around the first LED element 23a, and the key top portion 33 provided over the first LED element 23a and the switch contact pattern 21.

In the music piece data input device 1, as shown in FIG. 12, a plurality of the pad type switches 30a are arranged on the panel plate 13 vertically and horizontally in a matrix configuration. Each of these switches 30a is turned on or off via the key top portion 33 and the switch contact pattern 21 provided on the circuit substrate 20 under the switch 30a as noted previously, and such ON (hitting)/OFF operation and hitting intensity (operation intensity) of the switch 30a can be detected. To the individual switches 30a are assignable desired drum tone colors, such as those of a bass dram, snare drum, low torn, high torn, hi-hat close and hi-hat close. Thus, via the music piece data input device 1, music piece data can be generated which permit a performance with up to 16 different types of drum tone colors. Further, the function selecting switches 30b have predetermined functions, such as a function for switching between tone color banks, a function for starting any one of various setting modes, a function for stopping any one of the various setting modes, a function for switching between operation modes, a function for editing a parameter value, etc.

Further, the reinforcing plate 50 is provided underneath the circuit substrate 20 within the lower case 15. The reinforcing plate 50 is a metal flat plate-shaped member having a substantially rectangular outer shape accommodatable within the lower case 15. Opposite longitudinal side edge portions 50a of the reinforcing plate 50 are upwardly-bent reinforcing portions. Through-holes 53 for permitting insertion therethrough of the projections 15b of the lower case 15 and permitting the projections 15b to abut against the undersides of the switch contact patterns 21 of the circuit substrate 20 are formed in the reinforcing plate 50 at positions corresponding to the switch contact patterns 21 and projections 15b. The through-holes 53 each have a generally T shape. Insertion holes 50h for insertion therethrough of the screws (not shown) for fastening together the upper case 11 and the lower case 15 are also formed in corner portions of the reinforcing plate 50.

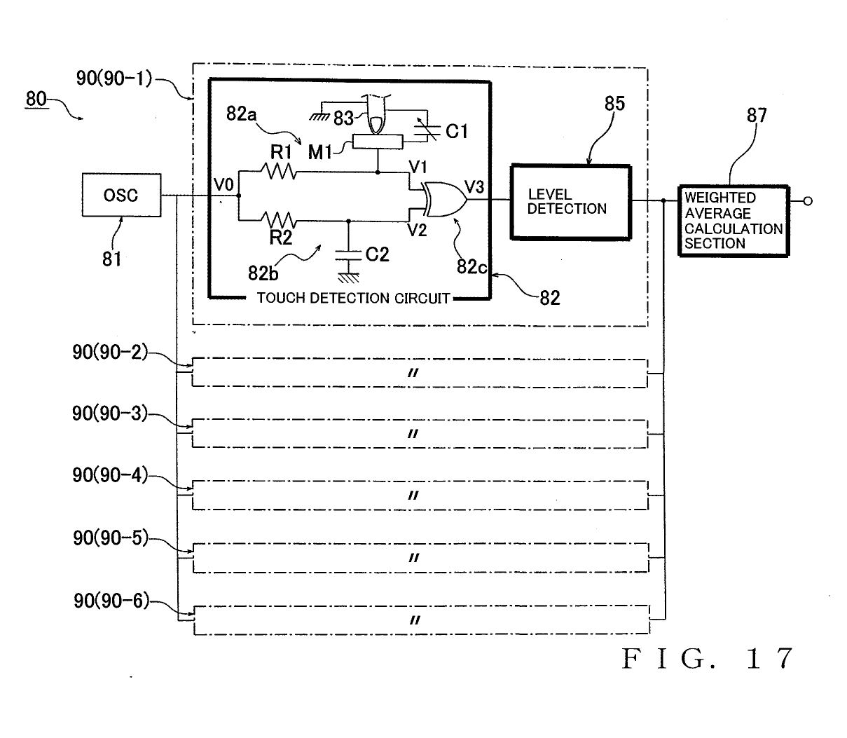

The following describe in greater detail the construction of the fader type controller 40. FIGS. 15A and 1513 show the fader substrate 41 of the fader type controller 40, of which FIG. 15A is a perspective view taken from above the upper surface 41a of the fader substrate 41 while FIG. 15B is a perspective view taken from below the lower surface 41b of the fader substrate 41. FIGS. 16A to 16C are views showing details of the fader type controller 40, of which FIG. 16A is a plan view of the fader section (fader type touch sensor) 43, FIG. 16B is a sectional side view of the fader type controller 40 taken along the X-X line of FIG. 16A, and FIG. 16C is a fragmentary enlarged sectional side view showing a detailed construction of an electrode section 45 provided on the fader substrate 41.

As shown in FIG. 13, the fader type controller 40 includes: the fader substrate (second circuit substrate) 41; the fader section 43 including the electrode section 45 provided on the upper surface 41a of the fader substrate 41, a thin plate-shaped cover sheet 42 covering the fader section 43, an elastic retention member 46 mounted on the lower surface 41b of the fader substrate 41, a light guiding member 47 retained by the retention member 46 between the circuit substrate 20 and the fader substrate 41, and the LED elements 23 (second LED elements 23b) mounted on the circuit substrate 20.

The fader substrate 41 is a hard substrate of a generally rectangular shape fixedly installed over a region (surrounded by the broken line Y in FIGS. 13 and 14) extending along one longitudinal side edge 20a of the circuit substrate 20. The fader section (fader type touch sensor) 43 for detecting a user's finger, operating the fader type controller 40, approaching or touching the fader section 43 is provided on the upper surface 41a of the fader type controller as seen in FIGS. 15A and 16A. The fader section (fader type touch sensor) 43, which is constructed similarly to the aforementioned fader sensor Fd, includes the electrode section 45 of a rectangular shape extending along the length of the fader substrate 41 so that an operated position where a user's finger has touched is detected via the electrode section 45.

A plurality of display sections 48 are sequentially arranged along the one-dimensional operating direction (longitudinal direction of the fader type controller 40) in overlapping relation to the fader section (fader type touch sensor) 43. More specifically, a plurality of (thirteen in the illustrated example) windows 43a are formed in a middle region, in a width direction, of the electrode section 45 at predetermined intervals along the longitudinal direction of the electrode section 45. Each window 43a has transparency or translucency for directing light, emitted from a corresponding one of the LED elements 23 provided on the circuit substrate 20, to the fader section 43. In the instant embodiment, the windows 43a are each in the form of an opening formed in the fader substrate 41. Namely, the display section 48 comprises one window 43a and one LED element 23 corresponding to the window 43a.

Further, as shown in FIG. 15B, the elastic retention member 46 in the form of a frame projecting downward is mounted on the lower surface 41b of the fader substrate 41. The elastic retention member 46 is formed of an elastic material, such as synthetic resin, adhesively fixed to the lower surface 41b of the fader substrate 41, and formed in a rectangular frame shape extending along the contour of the fader section 43. The elastic retention member 46 has a generally rectangular opening 46a formed vertically through the thickness thereof, and the light guiding member 47 is fitted in the opening 46a. The light guiding member 47 is an elongated rectangular member formed, for example, of transparent or semitransparent synthetic resin having translucency, and, as shown in FIG. 16B, the light guiding member 47 has upward projecting portions 47a formed on the upper surface thereof and fitted in a corresponding one of the windows 43a of the fader substrate 41. Thus, a plurality of such upward projecting portions 47a corresponding to the windows 43a are arranged on the light guiding member 47 in a straight row along the length of the light guiding member 47. Further, the light guiding member 47 has recessed portions 47b each formed in the lower surface thereof for accommodating therein the corresponding LED element 23 provided on the circuit substrate 20. In the light guiding member 47, the recessed portion 47b and the upward projecting portions 47a correspond to each other in position. The windows 43a, light guiding member 47 and the LED elements 23 provided on the circuit substrate 20 together constitute the display sections 48 for displaying an operated position by illumination of any one of the LED elements 23.

The fader substrate 41 having the electrode section 45 provided thereon is a multilayer printed circuit substrate, and the electrode section 45 has a width (e.g., 1.0-1.2 cm) greater than half of an operating finger of a human operator or user. As shown in FIG. 16A, the electrode section 45 has a plurality of electrode patterns M1, M2, . . . M6 successively arranged thereon along a longitudinal direction in which a user's operating finger slides (this direction will hereinafter be referred to as “sliding direction”). These electrode patterns M1 to M6 may be constructed completely identically to the electrode patterns P1 to P6 described above in relation to FIG. 3. Namely, the plurality of electrode patterns (touch sensitive pattern) M1 to M6 are sequentially arranged along the longitudinal operating direction and formed in such a manner that the boundary between each pair of adjoining ones of the electrode patterns M1 to M6 has a zigzag configuration or formation. More specifically, a thin band-like boundary (partitioning) section L1-L5 is provided between each pair of adjoining ones of the electrode patterns M1 to M6. As shown in a fragmentary enlarged sectional side view of FIG. 16C, the electrode pattern Mi is formed by attaching a copper film 45a to the fader substrate 41 over the upper surface of the circuit substrate 20, and the boundary portion Li is formed by removing (etching) parts of the copper film 45a from the fader substrate 41 over the circuit substrate 20. The upper surfaces of the electrode pattern Mi and boundary portions Li are covered with a resist layer 44 formed of an insulating material, and the upper surface of the resist layer 44 is covered with the cover sheet 42 adhered thereto.

Each of the boundary sections L1 to L5 has a generally M-like shape with a plurality of straight boundary lines extending obliquely relative to the sliding direction and with a plurality of peak and trough portions formed successively. Thus, a plurality of the boundary sections L1 to L5 exist at a same transverse position relative to the sliding direction (e.g., transverse position “Q” in FIG. 16A). Namely, at a same position transverse to the sliding direction, both of two adjoining electrode patterns M1 and M2, M2 and M3 or the like exist (in the illustrated example, adjoining electrode patterns M3 and M4 exist at the transverse position “Q”). Further, at that position, the window 43a is provided which is a blank region where no electrode pattern is formed. Namely, in the illustrated example, both of the electrode patterns M3 and M4, divided from each other by the blank region or window 43a and the boundary section L3 exist at the same transverse position Q relative to the sliding direction of the fader section 43. Note that each of the electrode patterns is formed in such a manner that portions thereof extend in the longitudinal direction while appropriately bypassing the window 43a in order to secure electrical connection for that electrode pattern despite the provision of the window 43a.

Thus, the electrode section 45 constitutes a band-shaped detection section provided continuously along the sliding direction. Namely, with this detection section 45, position information (in the sliding direction) of an approaching or touching finger can be acquired on the basis of the electrostatic-capacitance type touch sensing principle. Details of the detecting principle and detection circuitry will be discussed later.

Further, the cover sheet 42, which does not permit transmission therethrough of light of short wavelengths, is in the form of a thin plate-shaped synthetic resin film having a black color. When the red-light-emitting LED element 23, which is located underneath the window 43a for emitting red light of long wavelengths, has been illuminated to emit light to the cover sheet 42, the cover sheet 42 permits upward passage therethrough of the red light.

The fader substrate 41 of the fader type controller 40, provided with the aforementioned component parts, is supported over the LED element 23, mounted on the circuit substrate (first circuit substrate) 20, via the elastic retention member 46 and light guiding member 47, separately from the circuit substrate 20.

The fader substrate 41 is constructed as an assembly in advance by mounting the retention member 46 and light guiding member 47 to the lower surface of the fader substrate 41 and then mounting the cover sheet 42 to the upper surface of the fader substrate 41. In such an assembled state, a female connection terminal 41c provided on the lower surface 41b of the fader substrate 41 shown in FIG. 15B and a male connection terminal 27 provided on the upper surface of the circuit substrate 20 shown in FIG. 13 are fittingly connected with each other, but also small fitting projections 47c formed on the lower surface of the light guiding member 47 shown in FIG. 15B are fixedly press-fit into fitting holes (not shown) formed in the upper surface of the circuit substrate 20. In this manner, the fader substrate 41 is fixed to the circuit substrate 20.

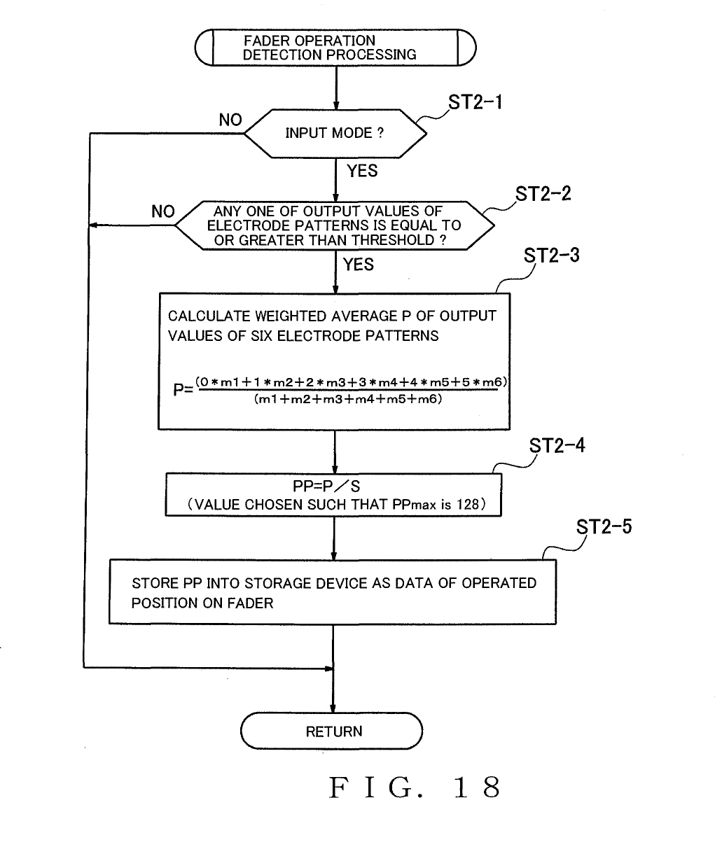

FIG. 17 is a block diagram schematically showing a construction of the operation detection circuitry (position information acquisition section) 80 for detecting operation on the aforementioned fader type controller 40. The following describe, with reference to FIG. 17, how operation (operated position) on the fader type controller 40 is detected. The operation detection circuitry 80 includes an oscillator 81 whose oscillating frequency f is set at a predetermined value (e.g., fixed value, such as 250 kHz or 400 kHz), and the operation detection circuitry 80 is constructed to adjust an acquisition amount of a signal level of the oscillator 81 in accordance with a relative distance between a finger of a hand that is a part of the user's body and the electrode pattern Mi when the user causes the finger to approach the fader section 43. In this manner, the operation detection circuitry (position information acquisition section) 80 detects a user-operated (touched) position, in the sliding direction, on the fader section 43.

Namely, in the operation detection circuitry 80 shown in FIG. 17, the oscillator 81 generates a predetermined frequency, and an output of the oscillator 81 is supplied to operation detection sections 90-1-90-6 corresponding to the individual electrode patterns M1 to M6. Because the operation detection sections 90-1-90-6 corresponding to the individual electrode patterns M1 to M6 are constructed identically to one another, only one of the operation detection sections 90-1 will be shown and described with illustration and description of the other operation detection sections 90-2-90-6 omitted.

The output of the oscillator 81 supplied to the operation detection sections 90-1 is then supplied to a touch detection circuit 82, where the supplied output V0 of the oscillator 81 is input to two delay circuits 82a and 82b. One of the delay circuits 82a is an RC integration circuit comprising a resistance R1 and electrostatic capacitance (condenser capacitance) C1 between the electrode pattern M1 and a finger of a human operator or user operating the electrode pattern M1, and the other delay circuit 82b is an RC integration circuit comprising a resistance R2 and a capacitor C2. The delay circuit 82a generates an output V1 of a waveform obtained by imparting a rectangular wave of the output V0 with a delay proportional to a product between the resistance value R1 and the condenser capacitance C1, while the delay circuit 82b generates an output V2 of a waveform obtained by imparting the rectangular wave of the output V0 with a delay proportional to a product between the resistance value R2 and the condenser capacitance C2. Namely, the delay circuit 82a outputs a waveform with a greater delay as the condenser capacitance C1 increases in response to the finger approaching the electrode pattern M1. The output V1 of the delay circuit 82a and the output V2 of the delay circuit 82b are supplied to an EXOR (Exclusive OR) circuit 82c. Then, the EXOR circuit 82c generates an output V3 of a waveform indicative of a phase difference between the waveform input from the delay circuit 82a and the waveform input from the delay circuit 82b. Namely, the output of the oscillator 81 is supplied to the two different integration circuits 82a and 82b and a comparison is made between delays of two signals output from the two different integration circuits 82a and 82b to acquire a signal indicative of a difference between the delays of the two signals output. In this way, it is possible to acquire a signal (PWM signal) of a duty ratio corresponding to a degree of proximity or touch of the finger to or on the electrode pattern M1. Then, the signal output from the EXOR circuit 82c is supplied to a level detection circuit 85, comprising an integration circuit etc., which converts the supplied signal into a level value. In this way, it is possible to obtain an output value of a level corresponding to a degree of proximity of the finger to the electrode pattern M1. Namely, as a ratio of a high-level state of the signal increases, the output level of the level detection circuit 85 becomes greater.

Thus, in each of the operation detection sections 90-1-90-6, the level detection circuit 85 generates a different output level value depending on a position of a finger in the longitudinal direction of the fader section 43. As a brief example, assuming that a maximum output level value of the level detection circuit 85 is “100”, and if a finger is at the transverse position Q in FIG. 16A, output value “98” is generated from the electrode pattern M3, output value “5” is generated from the electrode pattern M2, and output value “45” is generated from the electrode pattern M4. It should be appreciated that these values are just for explanatory of a tendency of the output value of the electrode pattern Mi and are never actual measurements. Relative positions of the finger to the individual electrode patterns M1 to M6 are detected on the basis of the levels of the above-mentioned output values. Further, output values from the operation detection sections 90-1-90-6 corresponding to the six electrode patterns M1 to M6 are supplied to a weighted average calculation section 87, which calculates a weighted average of the output values corresponding to the electrode patterns M1 to M6. Then, a position, in the sliding direction, of the finger on the electrode section 45 of the fader type controller 40 is acquired on the basis of the calculated weighted average. An operational sequence for the weighted average calculation section 87 to calculate the weighted average is as follows.

The weighted average of the output values from the six electrode patterns M1 to M6 can be calculated by the following Mathematical Expression (4):

P=(0*m1+1*m2+2*m3+3*m4+4*m5+5*m6)/(m1+m2+m3+m4+m5+m6) (4),

where m1 to m6 represent the output values of the electrode patterns M1 to M6. It should be noted that Mathematical Expression (4) is substantially equivalent to the aforementioned Mathematical Expression (1).

Then, a value PP is calculated by dividing the weighted average P by a predetermined value S as indicated in Mathematical Expression (5) below, where the predetermined value S is chosen such that a value PPMAX obtained by dividing a maximum value PMAX of the weighted average P by the predetermined value S is “128”. Further, PPP is any one of integral values “1” to “128”.

PP=P/S (5)

As one specific example way of calculating the value PP, the maximum value PMAX of the weighted average P may be set in a range of about “10000” to “100000”, while a minimum value PMIN of the weighted average P may be set at “0”.

The value PP calculated by Mathematical Expression (5) above is acquired as position data (MIDI data) indicative of an operated position, in the sliding direction, on the fader section 43.

As one brief example, the above-mentioned output values are substituted into Mathematical Expression (4) as follows:

$$\begin{matrix}P = ( 0 + 5 + 196 + 135 + 0 + 0 ) / ( 0 + 5 + 98 + 45 + 0 + 0 ) \\ = 336 / 148 \\ = 2.27\end{matrix}$$

Namely, when the center of the finger is at the “Q” position of FIG. 16A, P=2.27 is output.

Further, when there has occurred a finger touch such that the weighted average P takes the maximum value PMAX, i.e. when the finger has touched a position corresponding only to the electrode pattern M6 (i.e., right end portion of the electrode section 45 in FIG. 16A), P=(0+0+0+0+0+500)/(0+0+0+0+0+100)=5. Thus, the weighted average P can take a value in a range of “0” to “5”. With the aforementioned arrangements, it is possible to accurately detect a relative position of the finger in the sliding position of the electrode section 45 of the fader type controller 40.

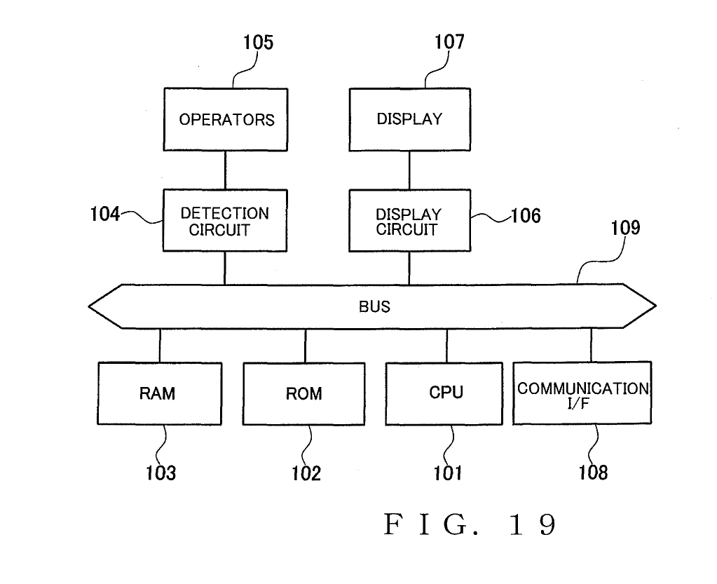

Note that, if it is difficult, due to the construction of the fader section 43 as shown in FIG. 16A, for the user to put its finger on the fader section 43 in such a manner that the maximum value of the weighted average P becomes “5” (i.e., in such a manner that the finger touches a position corresponding only to the electrode pattern M6, namely, a value is detected only with the electrode pattern M6), then the maximum value of the weighted average P becomes a value, for example, in a range of about “4.5” to “4.99”. In such a case too, the maximum value of the weighted average P must be set at “5” as long as there is a possibility of the maximum value of the weighted average P becoming “5”. However, in that case, a correction process for regarding, as the maximum value PMAX of the weighted average P, an appropriate value of the weighted average P (e.g., P=4.6) with the finger touching the right end portion of the electrode section 45 may be inserted between later-described steps ST2-3 and ST2-4 shown in FIG. 18 so that an operation of step ST2-4 is performed using the value of the weighted average P having been subjected to the correction process.

FIG. 18 shows an operational sequence of detection processing for detecting user's operation on the fader type controller 40. In the detection processing for detecting user's operation on the fader type controller 40 shown in FIG. 18, a determination is first made at step ST2-1 as to whether a processing mode of the music piece data input device 1 is an input mode capable of receiving user's operation on the fader type controller 40. If the processing mode of the music piece data input device 1 is not the input mode (NO determination at step ST2-1), no subsequent operation is performed. If, on the other hand, the processing mode of the music piece data input device 1 is the input mode (YEs determination at step S2-1), then a further determination is made at step ST2-2 as to whether any one of output values of the electrode patterns M1 to M6 (more specifically, output values of the corresponding operation detection sections 90-1-90-6) is equal to or greater than a predetermined threshold value. If all of the output values corresponding to the electrode patterns M1 to M6 are smaller than the predetermined threshold value (NO determination at step ST2-2), no subsequent operation is performed. If, on the other hand, any one of the output values corresponding to the electrode patterns M1 to M6 is equal to or greater than the predetermined threshold value (YES determination at step ST2-2), then a weighted average P of the output values corresponding to the six electrode patterns M1 to M6 is calculated by the aforementioned Mathematical Expression (1), at step ST2-3.

After that, by the aforementioned Mathematical Expression (5), a value PP is calculated by dividing a weighted average P, calculated by Mathematical Expression (4), by the predetermined value S, at step ST2-4. Then, at step ST2-5, the value PP calculated by Mathematical Expression (5) is stored into a storage device (such as a later-described PRAM 103) as position data (MIDI data) indicative of an operated position, in the sliding direction, on the fader section 43.

Further, because the operated position on the fader section 43 sequentially changes as the user's finger slidingly moves along the sliding direction of the fader section 43, detection of the operated position is successively performed through repetition of the operated position information calculation based on the aforementioned operating sequence. Also, during the detection of the user's sliding operation on the fader section 43, a corresponding one of the LEDs 23 of the display sections 38 is illuminated, on the basis of the detected operated position, to thereby visually display the operated position.

As set forth above, the fader type controller 40 provided in embodiment of the music piece data input device 1 includes: the touch-sensing type fader section 43 for detecting an operated position where the fader section 43 is operated by a finger, which is a part of a user's body, approaching or touching the fader section 43; the operation detection circuitry (position information acquisition section) 80 for acquiring operated position information based on the detection by the fader section 43, of the operated position; and the display sections 48 for visually displaying an operated position on the fader section 43. The fader section 43 has a band-shape section having a predetermined width, whose longitudinal direction corresponds to the sliding direction in which a part of the user's body slidingly moves along the surface thereof. The display sections 48 have the translucent windows 43a arranged in a middle region, in the width direction, of the fader section 43 along the sliding direction, and the LED elements (light emitting elements) 23 disposed underneath corresponding ones of the windows 43a in opposed relation thereto.

With such a fader type controller 40, where the display sections 48 functioning as a level meter are provided within the fader section (sensor region) 43, the feeling of operation on the fader section 43 and the position display by the display sections 48 are allowed to intuitively match each other. In addition, because the display sections 48 are provided within the fader section 43, the necessary installation area, in the width direction, of the fader type controller 40 can be significantly reduced as compared to the conventionally-known construction where display sections are provided on a side portion of the fader section along the sliding direction of the fader section.

Furthermore, the instant embodiment of the fader type controller 40 includes the electrode section 45 for detecting an operated position, and the operation detection circuitry 80 includes the operation detection section (circuitry) 90 for acquiring an operated position on the basis of a change of electrostatic capacitance between a finger and the electrode section 45, by which an electrostatic-capacitance type detection section is constituted.

Because the aforementioned electrostatic-capacitance type detection section has no mechanical component that moves in response to operation by the finger, the instant embodiment can achieve an enhanced durability against tong-time use and repeated use. Thus, it is possible to reduce a probability with which an inconvenience, such as a failure, will occur in the fader type controller 40, thereby reducing time and labor for maintenance.

Furthermore, the instant embodiment of the fader type controller 40 includes the boundary section Li extending obliquely zigzag relative to the sliding direction, a plurality of the electrode patterns Mi exits at a given same transverse position relative to the sliding direction. Thus, even where the windows 43a are provided in a middle region, in the width direction, of the fader section 43, an operated position detection value provided via each of the electrode patterns Mi can be output as a continuous value smoothly increasing or decreasing (varying) rather than as a value increasing or decreasing (varying) in a step function fashion. Thus, the instant embodiment can accurately detect an operated position via the fader section 43. Namely, the boundary section Li between each pair of adjoining electrode patterns Mi extends obliquely zigzag relative to the sliding direction, and thus, even when the human operator or user slidingly moves a single finger along the longitudinal direction of the fader section 43, each current operated position via the single finger can be sensed simultaneously via a plurality of the electrode patterns Mi, and an output of each of such electrode patterns Mi is produced as a value corresponding to a weighting imparted to that electrode pattern Mi (i.e., corresponding to a degree of proximity of the finger to the electrode pattern Mi). Then, on the basis of such output values, it is determined what degree of deviation a given electrode pattern Mi adjoining the electrode pattern Mi of the maximum output is outputting. An output obtained by synthesizing the outputs of these electrode patterns Mi takes a value varying smoothly (linearly) rather than stepwise. In this way, i is possible to obtain an accurate operated position, in the sliding direction, on the fader section 43. By contrast, with switch type detection sections disclosed, for example, in patent literatures 3 and 4, both input and output of a detection value take stepwise values, so that it is impossible to obtain a continuous output value to thereby perform accurate position detection.

Furthermore, although the windows 43a are provided in a middle region, in the width direction, of the fader section 43, the instant embodiment of the fader type controller 40 can prevent even more effectively the output value of the electrode pattern Mi from becoming an intermittent value (i.e., value increasing or decreasing in a step function fashion), because a plurality of parts of the boundary section Li exist at a same transverse position relative to the sliding direction of the fader section 43. As a result, with the fader type controller 40, an output value varying more smoothly can be obtained.

Furthermore, because the fader substrate 41 is a member separate from the circuit substrate 20 and fixedly installed over the circuit substrate 20, and because the LED elements 23 are mounted on the circuit board 20 at positions corresponding to the windows 43a, it is possible to readily assemble the fader type controller 40 having the display sections 48 provided within the fader section 43 by making, via separate steps, 1) the fader substrate 41 having mounted thereon the electrode section 45 and windows 43a that are components of the fader type controller 40 and 2) the circuit board 20 and the LED elements 23 mounted thereon and then installing the fader substrate 41 on the circuit board 20. In this way, it is possible to enhance the efficiency of steps of making an electronic component or device provided with the fader type controller 40. Further, because the component parts and circuit substrate 20 of the fader type controller 40 that were made at separate steps can be inspected in advance, problem-free component parts can be assembled into a final assembly. As a result, it is possible to enhance a yield of electronic components or devices provided with the fader type controller 40.

Furthermore, the instant embodiment of the fader type controller 40 includes a support section comprising the retention member 46 and light guiding member 47 for supporting the fader substrate 41 over the LED elements 23 mounted on the circuit substrate 20. The light guiding member 47, constituting the support section, also functions to direct light, emitted from the LED element 23, to the window 43a.

Because the light guiding member 47 functions to not only support the fader section 43 over the circuit board 20 but also direct light, emitted from the LED element 23, to the window 43a, the instant embodiment can reduce the number of necessary component parts of the fader controller 40.

Further, the embodiment of the music piece data input device (operator device) 1 includes: the fader type controller 40 constructed in the aforementioned manner, the switch type controller 30 including the switch contact patterns 21 formed on the circuit substrate 20 and the key top portions (operating component parts) 33 provided in opposed relation to the switch contact patterns 21; and the exterior casing 10 including the lower case 15 and the upper case 11 superposed on the lower case 15. The fader type controller 40 and the switch type controller 30 provided over the circuit substrate 20 are accommodated between the lower case and the upper case 11 of the exterior casing 10. Further, the LED elements 23 are mounted and arranged on the circuit substrate 20, and the fader section 43 is installed over the circuit substrate 20 in such a manner that its length extends along the arranged direction of the LED elements 23 (second LED elements 23b).

Furthermore, in the embodiment of the music piece data input device (operator device) 1, the upper case 11 includes the frame (first upper case) 12 whose upper edge portions 12a are superposed on the outer edge portions 15a of the lower case 15, and the panel plate (second upper case) 13 mounted inside the frame 12 and having the openings 13f and 13g to allow the fader type controller 40 and switch type controller 30 to be exposed to the outside of the exterior casing 10.

With such arrangements, it is possible to construct an external casing compatible with (sharable among) a plurality of types of music piece data input devices differing from each other in shape and arrangements on and over the circuit substrate 20, by just changing the shape of the panel plate 13. Thus, it is possible to construct a plurality of types of music piece data input devices by employing common specifications of the lower case 15, frame 12 and circuit substrate 20 while changing specifications of only the panel plate 13 and switch type controller 30. As a result, many types of music piece data input devices can be manufactured with a significantly reduced number of component parts.

The embodiment of the music piece data input device 1 comprises: the switch type controller 30 including the first LED elements 23a mounted on the circuit substrate 20 installed within the case 11, and a plurality of the switches 30a including the switch contact patterns 21 formed around the first LED elements 23a mounted on the circuit substrate 20 and the key top portions (operating component parts) 33 provided in opposed relation to the switch contact patterns 21; and the fader type controller 40 including the second LED elements 23b mounted on the circuit substrate 20, the light guiding member 47 having a plurality of through-holes or light transmitting holes disposed in corresponding relation to the second LED elements 23b, the fader substrate 41 installed over the circuit substrate 20 via the light guiding member 47, the touch sensitive fader section 43 provided on the fader substrate 41 and the windows 43a provided in the fader section 43 at positions corresponding to the through-holes or light transmitting holes. The switch contact patterns 21 are formed around at least some of the second LED elements 23b so that these second LED elements 23b are constructed similarly to the first LED elements 23a, and thus, such at least some of the second LED elements 23b are usable also as the first LED elements 23a of the switch type controller 30.

Thus, only one type of circuit substrate 20 can be used both for the above-mentioned embodiment of the music piece data input device 1 provided with both of the fader type controller 40 and the switch type controller 30 and for the embodiment of the music piece data input device 1-2 provided with only the switch type controller 30. Therefore, the same circuit substrate can be standardized for (can be made sharable among) a plurality of types of music piece data input devices, which can thereby reduce the number of necessary component parts and hence enhance the product manufacturing efficiency.

With the aforementioned embodiment of the fader type controller 40, a user's finger moving along the sliding direction of the fader section 43 simultaneously contacts a plurality of the electrode patterns Mi when it crosses any one of the window 43a, and thus, a detection value detecting an operated position can be prevented from becoming an intermittent value due to the provision of the window 43a, even where a blank region where no electrode pattern Mi is formed is provided in part of the electrode section 45 of the fader section 43 as noted above, information indicative of changing finger-operated positions can be obtained as smooth continuous values by a plurality of the electrode patterns Mi provided at the same transverse position as the blank region.

Further, whereas the embodiment has been described in relation to the case where the blank region of the fader section 43 where no electrode pattern Mi is formed is the window 43a in the form of an opening formed in the fader substrate 41 and the window 43a is a part of the display section 48 for directing light, emitted from the LED element 23, to the fader section 43, the blank region of the fader section 43 is not limited to the aforementioned construction and may be constructed in any other suitable manner. As an example, the blank region of the fader section 43 may be constructed as a switch section comprising a window provided in the fader substrate and a membrane type switch disposed in the window, although not specifically shown. Here, the membrane type switch may comprise two flexible substrates provided at a position corresponding to the window and spaced from each other by a predetermined distance via a spacer, and a pair of contact patterns formed on mutually-opposed surfaces of the two flexible substrates. In this case, when a finger operating the fader type controller along the sliding direction passes the window, the finger touches or contacts the membrane type switch so that the membrane type switch is turned on. Further, the membrane type switch may be assigned, for example, a function for locking sliding operation on the fader type controller at the position of the membrane type switch. Alternatively, the switch provided in the window formed in the fader substrate may be other than the membrane type switch, such as a push-button switch.

Furthermore, with the above-described embodiment of the music piece data input device 1, where not only a plurality of the electrode patterns Mi divided by the boundary section Li exist at a same transverse position relative to the sliding direction of the fader section 43 but also an operated position, in the sliding direction, on the fader section 43 is acquired on the basis of a weighted average of electrostatic capacitance detected by the individual electrode patterns Mi, it is possible to acquire, with a high accuracy, an operated position on the fader section 43 (i.e., operated position in the sliding direction).

Namely, the fader type controller 40 provided in the embodiment of the music piece data input device 1 calculates a weighted average of individual electrostatic capacitance produced between a plurality of the electrode patterns M1 to M6 and a finger approaching or touching the electrode patterns and uses the thus-calculated weighted average to obtain operated position information (touched position information) in the sliding direction of the fader type controller 40.

The following briefly describe a preferred form of use of the fader type controller 40. The above-described embodiment of the fader type controller 40 can be used, for example, as an operator for controlling a total sound volume in a mixer apparatus. In the case of realtime sound volume control, the calculated value PP is stored into the storage device and simultaneously subjected to output control as a sound volume of a sound source. In the case of non-realtime sound volume control, on the other hand, the calculated value PP is just subjected to output control as a sound volume of a sound source without being stored into the storage device. In addition, the fader type controller 40 can be used as an operator for performing sliding operation during creation of music data. In this case, if the operation mode is an editing mode following recording of three channels, such as vocal, guitar and keyboard, and the fader type controller 40 is used for sound volume adjustment of the vocal channel, then above-mentioned calculated value PP is re-stored into the storage device, together with recording data (time data), in such a manner that the sound volume of the vocal channel increases or decreases. Particularly, in a case where processing, such as fade-in/fade-out is performed on the vocal channel after the recording, it may be convenient if sound volume adjustment is performed using the fader type controller 40 provided in the instant embodiment of the music piece data input device 1.

Next, a description will be given about control circuitry provided in the music piece data input device 1. FIG. 19 is a block diagram showing an example construction of the control circuitry provided in the music piece data input device 1. As shown in FIG. 19, the control circuitry provided in the music piece data input device 1 is controlled by a microcomputer comprising a microprocessor unit (CPU) 101, a read-only memory (ROM) and a random-access memory (RAM) 103. The CPU 101 controls general behavior of the music piece data input device 1. To the CPU 101 are connected, via a bus 109, the ROM 102, the RAM 103, detection circuitry 104, a display circuit 106, a communication interface (I/F) 108, etc.

The ROM 102 stores therein various control programs to be executed by the CPU 101 and various data to be referenced by the CPU 101. The RAM 103 is used as a working memory for temporarily storing various data etc. generated as the CPU 101 executes a predetermined program, and as a memory for temporarily storing a currently-executed program and related data. Predetermined address regions are assigned to various functions and used as registers, flags, tables, memories, etc.

Operators 105 are operable to set whether or not to impart various functions and/or set various setting parameters. In the above-described embodiment, the pad type switches 30a, function selecting switches 30b and rotary encoder 30c of the switch type controller 30 and the fader type controller 40 are among the operators 105. The pad type switches 30a of the switch, type controller 30 are each operable to generate music piece data in response to detection of user's hitting operation thereon. Further, the function selecting switches 30b are each operable to output any of various information in response to user's detection of touch operation thereon. The detection circuitry 104 detects presence/absence of operation on the operators 105 etc., and it includes the aforementioned operation detection circuitry 80 for detecting operation on the fader type controller 40. The detection circuitry 104 not only generates a detection output responsive to detection of an operated position on the fader type controller 40, but also generates a detection output indicative of an ON/OFF state and current operation intensity when any one of the pad type switches 30a has been depressed or generates a detection output indicative of an ON/OFF state when any one of the function selecting switches 30b has been operated.

The communication interface (I/F) 108 is an interface connected to a general-purpose or dedicated communication cable or a wired or wireless communication network, such as a LAN, the Internet or a telephone line, so that it is connected to another computer (not shown) via the communication cable or communication network to communicate music piece data and various signals and information with the other computer. Note that such a communication interface (I/F) 108 may be of both of the wired and wireless types rather than either of the wired and wireless types. In response to user's hitting operation on any one of the switches 30a of the music piece data input device 1, music piece data of a drum tone color can be input to a computer where a music piece production software program is running.

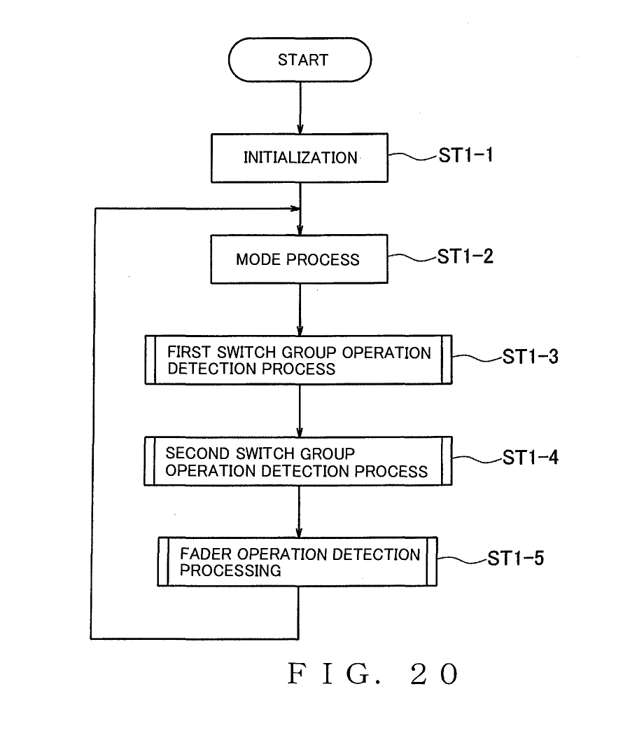

FIG. 20 is a flow chart showing a flow (main flow) of processing responsive to operation on the music piece data input device 1. An operational sequence of the processing responsive to operation on the music piece data input device 1 will be described with reference to the flow chart of FIG. 20. First, settings in various parts in the music piece data input device 1 are initialized at step ST1-1, and then a mode process is performed at step ST1-2. In the mode process, it is determined to which functions user's operation on the individual switches 30a and 30b of the switch type controller 30 and on the fader type controller 40 etc. should be assigned. Then, a detection process is performed at step ST1-3 for operation on a first switch group that is a group of the pad type switches 30a of the switch type controller 30. Then, a detection process is performed at step ST1-4 for operation on a second switch group that is a group of the function selecting switches 30b of the switch type controller 30. Then, detection processing is performed at step ST1-5 on user's operation on the fader type controller 40 (fader operation detection process). Upon generation of an instruction for performing the fader operation detection process at step ST1-5, the processing moves to a fader operation detection process flow (subroutine) shown in FIG. 18 for execution of the fader operation detection process. Upon completion of the fader operation detection process at step ST1-5, the processing reverts to the mode process of step ST2-2.

### Third Embodiment of the Controller

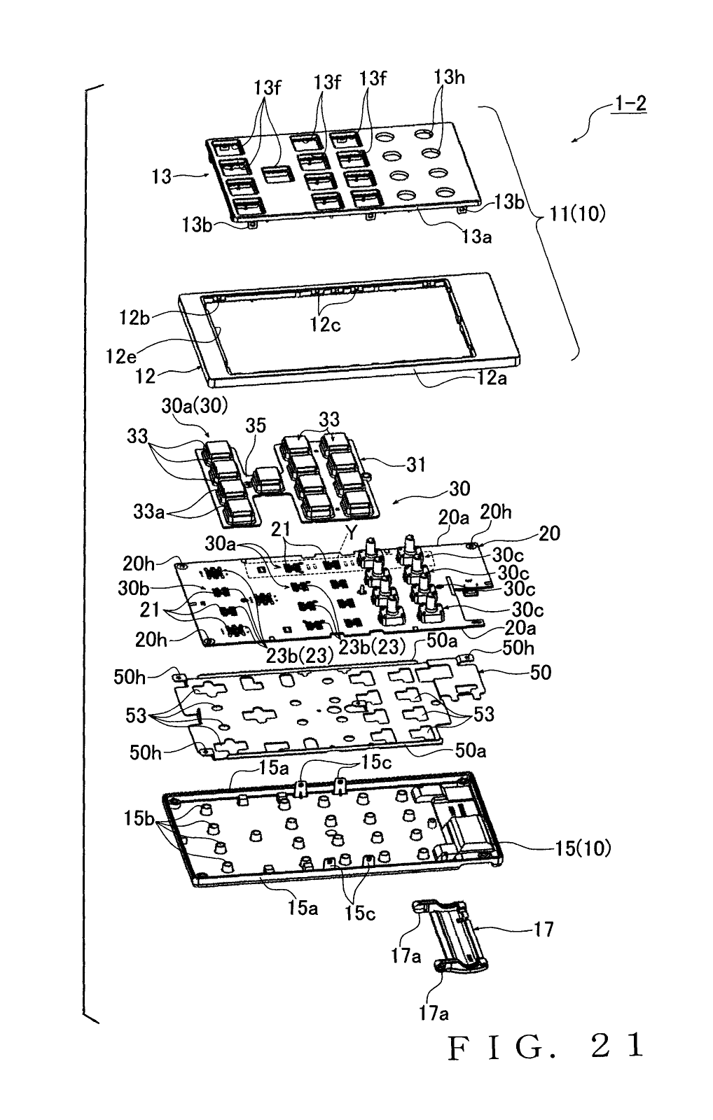

The following describe a third embodiment of the controller of the present invention. Note that, in the following description and corresponding drawings related to the third embodiment, similar elements to those in the second embodiment are indicated by the same reference numerals and characters as used for the second embodiment and will not be described here to avoid unnecessary duplication. Further, in the third embodiment, the other features than those to be described hereinbelow are the same as in the second embodiment, FIG. 21 is an exploded perspective view of a third embodiment of the music piece data input device 1-2 of the present invention.

The embodiment of the music piece data input device 1-2 does not include the fader type controller 40 provided in the second embodiment of the music piece data input device, but it includes, in the place of the fader type controller 40 on the circuit substrate 20 in the second embodiment, additional pad type switches 30a and rotary encoders 30c of the switch type controller 30. Because the fader type controller 40 is replaced with the pad type switches 30a and rotary encoders 30c in the instant embodiment of the music piece data input device 1-2 as noted above, the shapes and arrangements of the through-holes 13f and 13g formed in the panel plate 13 are changed, as compared to those in the second embodiment, in conformity with the pad type switches 30a and rotary encoders 30c.

The circuit substrate 20 in the instant embodiment of the music piece data input device 1-2 can be of the same construction as the circuit substrate 20 in the second embodiment of the music piece data input device 1. Namely, in the second embodiment of the music piece data input device 1, as noted previously, the switch contact patterns 21 are formed around each of some of the second LED elements 23b, and such second LED elements 23b around which the switch contact patterns 21 are formed are usable also as the first LED elements 23a for the switch type controller 30. Thus, in the instant embodiment of the music piece data input device 1-2, the switches 30a are additionally provided at positions corresponding to the second LED elements 23b usable also as the first LED elements 23a. In this manner, the circuit substrate 20 for use in the second embodiment of the music piece data input device 1 can be used as-is in the embodiment of the music piece data input device 1-2. As a result, the circuit substrate 20 can be standardized for (made sharable between) the plurality of types of music piece data input devices 1 and 1-2, which can thereby reduce the number of necessary types of component parts and hence enhance the product manufacturing efficiency.

Whereas the foregoing has described various embodiments of the present invention, the present invention is not limited to the above-described embodiments and may be modified variously within the scope of the technical idea described in the specification and drawing and claims. For example, the embodiments have been described above in relation to the case where the upper case 11 comprises two component parts, i.e. the frame (first upper case) 12 and the panel plate (second upper case) 13, and where the same upper case 11 can be used compatibly with (shared among) a plurality of types of music piece data input devices differing from each other in the type and number of operators. Alternatively, although not particularly shown, the upper ease 11 may comprise one component part and may be changed in shape so that the same upper case 11 can be used compatibly with a plurality of types of music piece data input devices differing from each other in the type and number of operators.

Further, in the above-described second and third embodiments of the fader type controller 40, the boundary section Li provided between each pair of adjoining electrode patterns Mi has a zigzag shape, the touch sensor of the fader type controller of the present invention is not so limited and may be constructed in any other desired manner. For example, although not particularly shown, the boundary section Li may be formed in a generally transversely-oriented U shape by a combination of straight lines parallel to and orthogonal to the sliding direction. With the boundary section of such a shape too, a plurality of the electrode patterns Mi divided by the boundary section Li can exist at a same transverse position of the electrode section 45 relative to the sliding direction. Further, in the second and third embodiments too, the touch sensor (fader section 43) may employ not only a plurality of the electrode patterns of the electrostatic capacitance type but also any other desired touch sensitive patterns of the pressure sensitive type and the like, similarly to the aforementioned.

This application is based on, and claims priority to, JP PA 2011-188034 filed on 30 Aug. 2011 and JP PA 2011-188805 filed on 31 Aug. 2011. The disclosure of the priority applications, in its entirety, including the drawings, claims, and the specification thereof, are incorporated herein by reference.

What is claimed is:

1. A touch sensor for detecting a user-operated position, in a one-dimensional operating direction, on the touch sensor, which comprises
a plurality of touch sensitive patterns formed on a surface of the touch sensor adapted to be touched by a user, said plurality of touch sensitive patterns being sequentially arranged along the operating direction with a boundary between each pair of adjoining ones of the touch sensitive patterns formed in a zigzag formation,
each of said touch sensitive patterns being configured to generate an output signal corresponding to user's touch on said surface.

2. The touch sensor as claimed in claim 1, wherein the touch sensitive patterns generate the output signals of different levels depending on degrees of the user's touch on the touch sensitive patterns.

3. The touch sensor as claimed in claim 1, wherein the touch sensitive patterns are electrode patterns.

4. The touch sensor as claimed in claim 1, wherein the zigzag formation of the boundary between the touch sensitive patterns is such that a user's finger simultaneously touches a plurality of the touch sensitive patterns as the finger touches said surface.

5. The touch sensor as claimed in claim 1, wherein the zigzag formation of the boundary between the touch sensitive patterns is such that there exists a transverse position, relative to the operating direction, where at least three of the touch sensitive patterns overlap with one another in a direction transverse to the operating direction.

6. The touch sensor as claimed in claim 1, wherein the zigzag formation of the boundary between the touch sensitive patterns is such that it presents symmetry with respect to a centerline, extending along the operating direction, of said surface.

7. The touch sensor as claimed in claim 1, which further comprises an arithmetic operation section configured to generate a detection signal indicative of a current operated position by synthesizing the output signals from the individual touch sensitive patterns.

8. The touch sensor as claimed in claim 7, wherein said arithmetic operation section generates the detection signal indicative of a current operated position by multiplying the output signals, generated from all of the touch sensitive patterns, by weighting coefficients set according to arranged order of the touch sensitive patterns and then calculating a weighted average of the output signals.

9. The touch sensor as claimed in claim 1, which further comprises a determination section configured to determine, on the basis of a distribution of the output signals generated from the individual touch sensitive patterns, whether one finger of the user has touched said surface or two fingers of the user have touched said surface.

10. The touch sensor as claimed in claim 9, wherein said determination section calculates a variance value of the output signals generated from the individual touch sensitive patterns, and determines, on the basis of a level of the calculated variance value, whether one finger of the user has touched said surface or two fingers of the user have touched said surface.

11. The touch sensor as claimed in claim 9, which further comprises an arithmetic operation section configured to, when said determination section determines that one finger of the user has touched said surface, generates a detection signal indicative of a single current operated position by synthesizing the output signals from all of the touch sensitive patterns.

12. The touch sensor as claimed in claim 11, wherein, when said determination operation section determines that one finger of the user has touched said surface, said arithmetic operation section generates the detection signal indicative of a single current operated position by multiplying the output signals, generated from all of the touch sensitive patterns, by weighting coefficients set according to arranged order of the touch sensitive patterns and then calculating a weighted average of the output signals having been multiplied by the weighting coefficients.

13. The touch sensor as claimed in claim 9, wherein, when said determination operation section determines that two fingers of the user have touched said surface, said arithmetic operation section, divides said touch sensitive patterns into two groups and, for each of the divided groups, generates a detection signal indicative of a current operated position by synthesizing the output signals generated from the touch sensitive patterns of the group.

14. The touch sensor as claimed in claim 13, wherein, when said determination operation section determines that two fingers of the user have touched said operating surface, said arithmetic operation section generates, for each of the divided groups, a detection signal indicative of a current operated position by multiplying the output signals, generated from the touch sensitive patterns of the group, by weighting coefficients set according to arranged order of the touch sensitive patterns and then calculating a weighted average of the output signals having been multiplied by the weighting coefficients.

15. A method for detecting an operated position on a touch sensor, the touch sensor being a sensor for detecting a user-touched, operated position, in a one-dimensional operating direction, on the touch sensor, the touch sensor including a surface adapted to be touched by the user, and a plurality of touch sensitive patterns formed on the surface, the plurality of touch sensitive patterns being sequentially arranged with a boundary between each pair of adjoining ones of the touch sensitive patterns formed in a zigzag formation, each of the touch sensitive patterns being configured to generate an output signal corresponding to user's touch on the surface,
said method comprising a generation step of generating a detection signal indicative of a current operated position by synthesizing the output signals generated from individual ones of the touch sensitive patterns.

16. The method as claimed in claim 15, wherein said generation step generates the detection signal indicative of a current operated position by multiplying the output signals, generated from all of the touch sensitive patterns, by weighting coefficients set according to arranged order of the touch sensitive patterns and then calculating a weighted average of the output signals having been multiplied by the weighting coefficients.

17. A controller having a panel surface operable by a user, comprising:
a touch sensor recited in claim 1 disposed on at least a part of the panel surface; and
a plurality of display sections arranged along a one-dimensional operating direction of said touch sensor.

18. The controller as claimed in claim 17, wherein each of said display sections includes a window exposed toward the panel surface, and a light emitting element disposed under the panel surface in opposed relation to the window.

19. The controller as claimed in claim 17, which includes a plurality of the touch sensors disposed on the panel surface, and wherein the plurality of display sections are provided in corresponding relation to individual ones of the touch sensors.

20. A fader type controller comprising:
a touch sensor provided on a surface adapted to be touched by a user, said touch sensor detecting a user-operated position, in a one-dimensional operating direction, on the touch sensor; and
a plurality of display sections sequentially arranged along the one-dimensional operating direction in overlapping relation to said touch sensor, each of said display sections comprising:
a window exposed toward said surface; and
a light emitting element disposed under the panel surface in opposed relation to the window.

21. The fader type controller as claimed in claim 20, which further comprises a first circuit substrate, and
a second circuit substrate having the touch sensor mounted thereon and the display sections provided therein, and
wherein said second circuit substrate is a member separate from said first circuit substrate and installed over said first circuit substrate, and
said light emitting element is mounted on said first circuit substrate.

22. The fader type controller as claimed in claim 21, wherein said touch sensor mounted on said second circuit substrate has no touch sensitive element at each of portions thereof corresponding to the windows.

23. The fader type controller as claimed in claim 21, which further comprises support members for supporting said second circuit substrate above the light emitting elements, and
wherein said support members have a function of directing light, emitted from the light emitting elements, to corresponding ones of the windows.

24. A controller device comprising:
a fader type controller as recited in claim 21;
a switch type controller including a plurality of switches, each of the switches comprising a contact pattern formed on said first circuit substrate of the fader type controller, and an operating component part disposed in opposed relation to the contact pattern; and
an exterior casing comprising at least a lower case and an upper case provided on the lower case in superposed relation thereto, and
wherein said fader type controller and said switch type controller are accommodated between the lower case and the upper case of said exterior casing,
a plurality of the light emitting elements are arranged on said first circuit substrate, and
said fader type controller is installed over said first circuit substrate in such a manner that a length thereof extends along an arranged direction of the light emitting elements on said first circuit substrate.

25. The controller device as claimed in claim 24, wherein the upper case includes a first upper case of a frame shape having edge portions superposed on edge portions of the lower case, and a second upper case mounted inside the first upper case and having an opening for exposing said fader type controller and said switch type controller to outside of said exterior casing.
